(19) United States
(12) Patent Application Publication
(10) Pub. No.: US 2005/0159835 A1
(43) Pub. Date: Jul. 21, 2005

(54) Device for and method of creating a model for determining relationship between process and quality

(76) Inventors: Kentaro Yamada, Osaka (JP); Yukihiro Aoyama, Yao (JP); Makoto Ogawa, Kawasaki (JP); Toshikazu Nakamura, Kawasaki (JP); Yoshikazu Aikawa, Tokyo (JP)

Correspondence Address: BEYER WEAVER & THOMAS LLP, P.O. BOX 70250, OAKLAND, CA, 94612-0250, US

(21) Appl. No.: 11/021,112

(22) Filed: Dec. 23, 2004

(30) Foreign Application Priority Data
Dec. 26, 2003 (JP) 2003-435947

(51) Int. Cl. H04L 9/00; G06F 19/00; G06G 7/48

(52) U.S. Cl. 700/109; 703/6

(57) ABSTRACT

A model creating device inputs process status data that are obtained in time series during a period during which each of process steps of a process is carried out and are related to status of this process, as well as inspection result data related to object articles that were processed by said process. An extracting part extracts a characteristic quantity from the process status data for every unit object article and for every process step. An analyzing part carries out an analysis by data mining by using the characteristic quantities and inspection result data in correlation with the unit object articles and creates a process-quality model that shows a relationship between the correlated characteristic quantities and inspection result data.

Priority is claimed on Japanese Patent Application 2003-435947 filed Dec. 26, 2003.

### BACKGROUND OF THE INVENTION

This invention relates to the relationship between the quality of products and the production process including a plurality of steps by which they are produced, and more particularly to a device for and a method of creating a process-quality model for obtaining process status data that are considered to affect the quality of processed products and data on their quality and thereby determining a relationship between quantities that are extracted from such process status data and serve to characterize the process and the obtained quality data.

Production processes for products of many kinds inclusive of semiconductor products must be maintained appropriately in order to improve their yield and to maintain their improved yield.

Japanese Patent Publication Tokkai 9-219347 describes an analysis of a correlation between production status data such as the degree of vacuum and heater power of a CVD device and product data such as the yield and the electrical characteristics of the produced semiconductor devices such that the results of such analysis can be used to set a standard for management of the production status data and to investigate the cause of any abnormal condition.

Japanese Patent Publication Tokkai 2002-323924 describes a method of using process history data on a plurality of production devices with similar capabilities that are being used for a mass production process, indicative of which production device was used for the processing and result data that indicate the quality of the processes such that an analysis by so-called data mining can be carried out to identify defective devices that significantly cause the lowering of the yield.

With the technology of aforementioned Japanese Patent Publication Tokkai 9-219347, the user can learn an appropriate management standard regarding any observed parameter but it is left to the user to determine which of the parameters should be observed. In other words, the user cannot determine whether any of the parameters that have not been observed are significantly affecting the yield.

With the technology of aforementioned Japanese Patent Publication Tokkai 2002-323924, it is possible to identify defective devices but the user cannot further analyze the cause of the defects.

In order to improve the yield of production or to maintain it at a high level more effectively, it is not sufficient to identify defective devices but is required to also identify production data related to the quality of the products. Moreover, the range of data on quality that can be identified should, if possible, be greater than the range within which users would normally predict such data to be. In other words, it will be desirable to be able to identify production data that users normally would not expect to be causing a trouble. Neither of the aforementioned prior art technologies is equipped to satisfy such a requirement.

### SUMMARY OF THE INVENTION

The present invention therefore relates to a device for and a method of creating a model that can be used for predicting the quality of a target product on the basis of many kinds of data, which can be obtained about the status of its production process but may not necessarily be predictable regarding their correlation with the quality. Other objects of this invention will become clear to the reader from the description that follows.

A model creating device according to this invention is characterized as being adapted to input process status data which are obtained in time series during a period while each process step comprising a process is being carried out and inspection result data related to object articles processed by this process and to create a process-quality model which shows the relationship between a characteristic quantity extracted from the process status data and the inspection result data and comprising a first input part that inputs the process status data, a second input part that inputs the inspection result data, an extracting part and an analyzing part. The extracting part extracts a characteristic quantity from the process status data for every unit object article (hereinafter defined as either one object article or a group of object articles) and for every process step. The analyzing part carries out an analysis by data mining by using the characteristic quantities and inspection result data in correlation with the unit object articles and thereby creates a process-quality model that shows relationship between the correlated characteristic quantities and inspection result data.

In the above, the “process” may be a production process but need not be so limited. Object articles that may be produced by the production process of this invention include semiconductor devices, flat panel displays, medicaments, cosmetic articles, food items, chemicals, steel products, paper and pulp products, products made of injection molding and resins. Examples of non-production processes that may be considered as the process according to this invention include water treatment, garbage disposal, treatment of human wastes, gas supply, electrical power production and air conditioning.

Data mining is a method of extracting patterns and rules from a large database, and routines such as decision tree analysis and regression tree analysis are known.

The first input part and the second input part may be realized by a single component.

With a model creating device structured as explained above, a process-quality model capable of predicting the quality of an object article can be created on the basis of data of many kinds that can be obtained on the status of the process and not limited by anticipations related to the quality. Since process status data obtained in time series are used, in particular, a model can be created on the basis of a sufficient amount of data. Since characteristic quantities extracted for individual process steps are used, furthermore, a model which reflects the characteristics of each process step well can be created.

When such a model creating device is used for processes of more than one kind, a process-quality model will be created for each kind. It is preferable to store such plurality of models in the model creating device or in some other device in correlation with the kind of processes for which each was created.

For extracting a characteristic quantity for each of unit object articles, the model creating device of this invention may further comprise a third input part that inputs object ID data for identifying the unit object articles in correlation with the characteristic quantities. The second input part inputs the inspection result data in correlation with the object ID data such that the characteristic quantities and the inspection result data can be correlated for relating to a common unit object article. An inspection result correlating part is further provided for correlating the characteristic quantities and the inspection results having same object ID data. The analyzing part carries out the analysis by using the characteristic quantity and the inspection result data correlated by the inspection result correlating part.

In the above, the third input part may be realized by the same component as the first input part or the second input part.

At least the following two situations may be considered in which the object ID data are inputted in correlation with the characteristic quantity. One of these two situations is where process status data preliminarily correlated with unit object articles are provided as input data to the model creating device such as when the controller of the process device recognizes the ID data of the object articles being processed and this controller correlates the process status data with the object ID data to output to the model creating device. In such a situation, the model creating device need not to carry out any process for establishing correspondence between the unit object articles and the process status data. Since the characteristic quantities are extracted from the process status data, if process status data correlated to the unit object articles are inputted, the model creating device can correlate the unit object articles with the characteristic quantities.

The other situation is where process status data not correlated with the unit object articles are provided and the model creating device carries out the correlation process between the unit object articles and the process status data such as when process status data are provided as input data in correlation with the time at which they are acquired and object ID data are given as another input data to the model creating device in correlation with the time at which these articles were processed. In such a situation, the model creating device can establish correlation between them from the coincidence of proximity of their times.

The model creating device of this invention may further comprise a step correlating part that correlates the process steps and the process status data such that the characteristic quantities can be extracted for each of the process steps. The step correlating part may be adapted to create the process steps by using the timings of changes in specified one of the process status data, correlating the created process steps with the process status data. It may be up to the operator to decide which timings of changes should be used to create the process steps and to make an input to the model creating device. This command may be preliminarily set in the model creating device. The start and the end of a process step may be determined by using data on only a single item of the process status data or by way of a logical calculation based on a plurality of items. The timing of the start and the end may be determined by using logical calculations based on a single item or a plurality of items.

In addition to the above, the step correlating part may further be adapted to create at least some of these process steps by setting a period by using the timings of changes in specified one of the process status data and by further dividing this set period. With the step correlating part thus adapted, divisions into process steps can be effected even during a period in which there is no clear change in the process status data and a process-quality model can be created reflecting even short-term changes in a characteristic quantity that may have occurred before such divisions.

A step correlating part may be structured differently for a situation where process status data as input data for the model creating device are provided in correlation with the times at which they were obtained and other input data identifying the process steps are provided to the model creating device in correlation with the times at which these process steps are carried out. Such a step correlation part will correlate the process steps and the process status data on the basis of coincidence or proximity of these times.

The step correlating part may be structured yet differently for a different situation where process status data as input data for the model creating device are provided in correlation with the times at which they were obtained and a synchronization signal is provided at a reference time related to the process execution. Such a step correlating part is provided with process step plan data which contain data such as the starting time, ending time and time duration of each process step and can determine the time to execute each process step if the reference time is given and is adapted to correlate the process step with the process status data by using the time data corresponding to the step status data and the time at which each process step is executed, obtained from the process step plan data and the synchronization signal.

There are situations where a step correlating part is not needed by the model creating device such as when process status data preliminarily correlated with the process steps are provided as input data to the model creating device. This is the case, for example, when a way to divide a process step is already set in a controller of a process device and this controller outputs the process status data to the model creating device by correlating them with the process steps. In such a situation, there is no need for the model creating device to carry out any processing for correlating the process steps with the process status data.

The model creating device of this invention provided with a step correlation part may further comprise a memory device for storing process status data obtained continuously over a plurality of process steps at a fixed frequency period shorter than the shortest of the process steps, in correlation with the times at which the process status data were obtained, the step correlating part serving to read process status data to be used for processing from the memory device. This simplifies the preparation work for obtaining the process status data such as the work of preliminary setting because the process status data are obtained at a fixed frequency. Since the process status data are obtained at a fixed frequency over a plurality of process steps, furthermore, it becomes easier to input process status data not correlated to the process steps to create a process step based on the timing of change in the process status data within the model creating device. In the above, the memory device may be adapted to store process status data obtained over several periods with intervening periods. In this situation, the periods for getting the data may or may not correspond to the process steps.

If the process includes a wait period which can be correlated to a specified one of unit object articles, the memory device may store process data obtained during this wait period in correlation with the time at which the process data were obtained, and the step correlating part may read out the process data obtained during the wait period from the memory device and process this wait period as one of the process steps. In this manner, the status of the process device during such a wait period can also be reflected in the process-quality model.

The model creating device of this invention may be such that, when at least some of the data items of the process data inputted by the first input part are common data items among a group of the process steps, the characteristic quantity extracted by the extracting part includes common items that are extractable from the common data items of the process status data for each of the process steps of the group. This has the advantage that data can be more exhaustingly used for creating the process-quality model.

The relationship between the periods of the process steps and the process status data is only required to be as described above. It is not necessary to be understood at the time of the input to which steps the process status data correspond.

The following examples may be considered for a situation where the process status data have common items. Firstly, there is a situation where a plurality of process steps are carried out by using a single process device. Since a common device is used in each process step, process status data with common items can be obtained. Secondly, the situation may be such that there are a plurality of process devices of the same kind being used for carrying out one or more process steps. Since the kinds of the process devices are common even among process steps being carried out by different process devices, process status data with common data items can be obtained.

In either situation, it is desirable to make the items of obtained process status data and items of extracted characteristic quantities as common as possible among the process steps. If possible, it is even more desirable to make all items of obtained process status data and items of extracted characteristic quantities common. In this way, the data to be used for making a process-quality model even more exhaustive.

In the case of a process employing a plurality of process devices, the model creating device of this invention may further comprise a fourth input part that inputs wait time data in correlation with object ID data identifying a unit object article. “Wait time” is herein defined as the time spent from when an object article being processed is processed by one of these process devices until when this object article is processed by another of these process devices, and the term “wait time data” will be herein used to refer to data on the wait time. The analyzing part carries out the analysis by using the wait time data correlated with unit object article as one of the characteristic quantities.

In the above, the fourth input part may be the same as any of the aforementioned three input parts and is adapted to input wait time data correlated to object article ID data. If both wait time data and object article ID data have common attached data such as time data, such attached data may be used as a key by the model creating device to correlate the wait time data with unit object articles.

The model creating device, described above as being provided with an inspection result correlating part that correlates the characteristic quantity and the inspection results having same object ID data in common, may further comprise a fifth input part that inputs fault data regarding the process device used in the process in correlation with the object ID data, the inspection result correlating part correlating those of the characteristic quantities, the inspection result data and fault data with common object ID data, the analyzing part creating a process-quality model containing relationship between characteristic quantities and fault data by carrying out the analysis by using the characteristic quantities, the inspection result data and the fault data that are correlated by the inspection result correlating part. In the above, the fifth input part may be the same as any of the aforementioned four input parts.

The model creating device, described above as being provided with an inspection result correlating part that correlates the characteristic quantity and the inspection results having same object ID data in common, may further comprise a sixth input part that inputs supplemental data, which are given generally to one or more of the process steps, in correlation with the object ID data, the inspection result correlating part correlating the characteristic quantities, the inspection result data and the supplemental data with common object ID data, the analyzing part creating a process-quality model by carrying out the analysis by using the characteristic quantities, the inspection result data and the supplemental data that are correlated by the inspection result correlating part. In the above, the sixth input part may be the same as any of the aforementioned five input parts. With such a structure, the operator can make supplemental data related, for example, to the operator, maintenance and environmental conditions to be reflected to the created process-quality model.

The model creating device of this invention may further comprise a time series analyzer part that creates a time series prediction model showing prediction on changes in the characteristic quantities. The time series analyzer part may be adapted to create the time series prediction model regarding one of the characteristic quantities that has an item in the process-quality model. With such a time series analyzer part, a useful time series prediction becomes possible because time series prediction becomes possible on characteristic quantities heavily related to the quality.

The model creating device of this invention may further comprise a model providing part that accumulates and provides preliminarily created process-quality models and a judging part that detects an abnormality and identifies the kind of the abnormality by applying characteristic quantities to the process-quantity model. With such parts further provided, detection of abnormalities and their kinds can be predicted on object articles before an inspection is made or without making any inspections.

The model creating device described above, as being provided with a model provided part and a judging part, may further comprise a time series analyzer part that creates a time series prediction model which predicts changes in the characteristic quantities, the judging part detecting abnormalities to be predicted for future and identifying kinds of the abnormalities by applying characteristic quantities predicted by the time series prediction model to the process-quality model. In the above, the detection of predictable abnormality may include identification of the time at which the predicted abnormality will occur.

If the process-quality model is expressed in the form of rule formulas, it is preferable to form the time series prediction model regarding a characteristic quantity having an item in this rule formula of the process-quality model. In this situation, it is further preferable to use a numerical value appearing in the rule formula as a threshold value. It is an appropriate way of applying this characteristic quantity to the process-quality model to detect a fault in this manner.

The model creating device described above, as being provided with the fifth input part that inputs fault data, may further comprise a time series analyzer part that creates a time series prediction model which predicts changes in the characteristic quantities, a model providing part that accumulates and provides preliminarily created process-quality models, and a fault judging part that detects a fault predicted to occur in future and identifies the kind of the fault by applying the characteristic quantities to the process-quantity model. In this case, too, the detection of predicted fault in a process device may include identification of the time when the predicted abnormality will occur.

The analyzing part of the model creating device of this invention may be adapted to extract a partial model from a process-quality model created by using those of the characteristic quantities corresponding to a group of process steps such that the conclusion of the model is determined only by the characteristic quantities corresponding to a portion of this group of process steps. With the analyzing part thus structured, a partial model thus extracted can be utilized because detection and identification of an abnormality become possible as soon as the process status data from the portion of process steps related to the extracted partial model have been obtained.

The part of the process steps related to the partial model may be made to correspond to a part of the process devices such as a single process device or a specified plurality of process devices. In particular when an inspection of object articles is done after the processing by this single process device or this specified plurality of process devices is done and thereafter the processing by some other process devices is done, it is desirable to be able, before the processing by such other process devices is undertaken, to detect abnormalities and to identify the kinds of abnormalities that have a probability of being detected by such inspection. A partial model can be used for detecting and identifying the kinds of such abnormalities.

A processing system according to this invention is characterized as comprising a process device for carrying out a process, a process data collecting device for collecting from the process device process status data that are related to status of the process and are obtained in time series during a period during which process steps of the process are carried out, an inspection device that inspects object articles on which the process is carried out, and a model creating device that inputs the process status data from the process data collecting device, inputs inspection result data and creates a process-quality model which shows a relationship between a characteristic quantity extracted from the process status data and the inspection result data. In the above, the model creating device is characterized as comprising a first input part that inputs the process status data, a second input part that inputs the inspection result data, an extracting part that extracts the characteristic quantity from the process status data for every unit object article and for every process step, the unit object articles being either one object article or a group of object articles, and an analyzing part that carries out an analysis by data mining by using the characteristic quantities and inspection result data in correlation with the unit object articles, thereby creating a process-quality model that shows relationship between the correlated characteristic quantities and inspection result data.

In the above, the process data collecting device may be internally contained by the process device. A single process data collecting device may be provided in common for a plurality of process devices. The processing system may further comprise an inspection data collecting device such that the model creating device inputs the inspection result data from this inspection result data collecting device.

A plasma process system according to this invention is characterized as comprising a process device having a plasma chamber for a plasma process, a process data collecting device for collecting from the process device process status data that are related to status of the plasma process and are obtained in time series during a period during which each of process steps including a pre-treatment step before a plasma is generated, a main treatment step while the plasma is being generated and a post-treatment step after the generation of the plasma is stopped, is carried out, an inspection device that inspects object articles on which the plasma process is carried out, a model creating device that inputs the process status data from the process data collecting device, inputs inspection result data and creates a process-quality model which shows a relationship between a characteristic quantity extracted from the process status data and the inspection result data. In the above, the model creating device is characterized as comprising a first input part that inputs the process status data, a second input part that inputs the inspection result data, an extracting part that extracts the characteristic quantity from the process status data for every unit object article and for every process step, the unit object articles being either one object article or a group of object articles, and an analyzing part that carries out an analysis by data mining by using the characteristic quantities and inspection result data in correlation with the unit object articles, thereby creating a process-quality model that shows relationship between the correlated characteristic quantities and inspection result data.

A method of creating a process-quality model according to this invention may be characterized as comprising the steps of obtaining process status data and inspection result data, wherein the process status data are related to status of a process and obtained in time series during a period during which each of process steps comprising the process is carried out, and the inspection result data are related to object articles that were processed by the process, extracting a characteristic quantity from the process status data for each unit object article and each process step, wherein the unit object article is either one object article or a group of object articles, correlating the characteristic quantities and the process status data that are related in common to one of the unit object articles, and creating the process-quality model by carrying out an analysis by data mining by using the correlated characteristic quantity and process status data, wherein the process-quality model shows a relationship between the correlated characteristic quantity and inspection result data.

A fault detection and classification (FDC) method according to this invention may be characterized as comprising the steps of obtaining process status data and inspection result data, wherein the process status data are related to status of a process and obtained in time series during a period during which each of process steps comprising the process is carried out, and the inspection result data are related to object articles that were processed by the process, extracting a characteristic quantity from the process status data for each unit object article and each process step, wherein the unit object article is either one object article or a group of object articles, correlating the characteristic quantities and the process status data being related in common to one of the unit object articles, creating a process-quality model by carrying out an analysis by data mining by using the correlated characteristic quantity and process status data, wherein the process-quality model shows a relationship between the correlated characteristic quantity and inspection result data, obtaining process status data and inspection result data for the same process but related to different unit object articles, extracting a characteristic quantity from the process status data for the different unit object articles and process steps, and detecting a fault and identify its kind by applying the extracted characteristic quantity for the different unit object articles and process steps to the created process-quality model.

Another fault detection and classification (FDC) method according to this invention may be characterized as comprising the steps of obtaining process status data and inspection result data, wherein the process status data are related to status of a process and obtained in time series during a period during which each of process steps comprising the process is carried out, and the inspection result data are related to object articles that were processed by said process, extracting a characteristic quantity from the process status data for each unit object article and each process step, wherein the unit object article is either one object article or a group of object articles, correlating the characteristic quantities and process status data related in common to one of the unit object articles, creating a process-quality model by carrying out an analysis by data mining by using the correlated characteristic quantity and process status data, wherein the process-quality model shows a relationship between the correlated characteristic quantity and inspection result data, obtaining process status data and inspection result data for the same process but related to different unit object articles, extracting a characteristic quantity from the process status data for the different unit object articles and process steps, creating a time series prediction model that predicts changes in the characteristic quantity from the process status data for the different unit object articles and process steps, and detecting a fault and identifying its kind that may be predicted to occur in the future by applying the changes predicted by the time series prediction model to the process-quality model. In the above, the fault to be predicted may include the timing for the occurrence of such a fault.

Still another fault detection and classification (FDC) method according to this invention may be characterized as comprising the steps of obtaining process status data that are related to status of a process and obtained in time series during a period during which each of process steps comprising the process is carried out, obtaining object article ID data in correlation with characteristic quantities, wherein the object article ID data identify unit object articles and the unit object articles are each either one object article or a group of object articles, obtaining inspection result data related to object articles processed by the process in correlation with the object article ID data, obtaining fault data related to a process device used for the process in correlation with the object article ID data, extracting a characteristic quantity from the process status data for each of unit object articles and process steps, correlating characteristic quantities, inspection result data and fault data for having common object article ID data, creating a process-quality model by carrying out an analysis by data mining by using the correlated characteristic quantity, process status data and fault data, wherein the process-quality model shows a relationship among the correlated characteristic quantity, inspection result data and fault data, obtaining process status data, inspection result data and fault data for the same process but related to different unit object articles, extracting a characteristic quantity from the process status data for the different unit object articles and process steps, creating a time series prediction model that predicts changes in the characteristic quantities from the process status data for the different unit object articles and process steps, and detecting a fault in the process device and identifying its kind predicted to occur in future by applying the changes predicted by the time series prediction model to the process-quality model. In the above, the fault to be predicted may include the timing for the occurrence of such a fault.

By means of a model creating device of this invention, it is therefore possible to create a process-quality model capable of predicting the quality of object articles on the basis of data of many kinds that are obtainable about the status of the process device and without being limited by the prediction related to the quality. Since process status data obtained in time series are used, in particular, the model can be created by using a sufficient quantity of data. Since characteristic quantities extracted for each process step are used, furthermore. a model that reflects the characteristics of each of process steps can be created.

### BRIEF DESCRIPTION OF THE DRAWINGS

FIG. 1 is a schematic block diagram of a semiconductor production system including a model creating device according to a first embodiment of this invention.

FIG. 2 is a schematic block diagram for showing the internal structure of an example of process device.

FIG. 3 is a schematic block diagram for showing the internal structure of the plasma chamber and some components connected thereto.

FIG. 4 is a drawing for showing the connection of the devices of the system shown in FIG. 1 from the point of view of the data that are transmitted and received.

FIG. 5 is a schematic block diagram for showing the internal structure of the model creating device.

FIG. 6 is a drawing for showing an example of data to be inputted to the model creating device.

FIG. 7 is an example of input screen of weather/earthquake data displayed on the display device.

FIG. 8 is a flowchart for explaining the processes by the process data collecting device for collecting data and registering data in the primary data memory.

FIGS. 9-11 show an example of the structure of data stored in the primary data memory.

FIGS. 12A a 12B are drawings for showing a method of inspecting film thickness data.

FIG. 13 shows an example of the structure of data stored in the inspection data memory.

FIG. 14 is an example of input screen of fault data displayed on the display device.

FIG. 15 is an example of the structure of data stored in the fault data memory.

FIG. 16 is an example of method of correlating with steps in the case of a film-forming process.

FIGS. 17A, 17B, 17C and 17D (together referred to as FIG. 17) are drawings of data change from which the timing of start and end of a step can be determined.

FIG. 18 shows an example of the start and the end of a process step.

FIGS. 19A, 19B and 19C (together referred to as FIG. 19) are for explaining an example of dividing a process step further into smaller steps.

FIGS. 20 and 21 show an example of the structure of data stored in the step data memory.

FIGS. 22A and 22B (together referred to as FIG. 22) are for explaining the internal data of the edited inspection data memory.

FIG. 23 is an example of the structure of edited inspection data stored in the edited inspection data memory.

FIG. 24 is an example of table with which the fault data editing part is provided, showing the correspondence between the details of input related to faults and the fault codes.

FIG. 25 is a table showing an example of internal structure of the edited fault data memory.

FIG. 26 is a drawing for showing the functions of the data combining part.

FIG. 27 is an example of process-quality model.

FIG. 28 is a graph showing an example of application of time series prediction model.

FIG. 29 is a schematic block diagram showing the internal structure of a model creating device according to a second embodiment of the invention.

FIG. 30 is a schematic diagram of the present invention as applied to a device for applying an alignment film for the production of a liquid crystal. % FIG. 31 is a schematic block diagram of a third embodiment of the invention.

FIG. 32 is a table showing an example of data structure of the general data memory of the third embodiment of the invention.

FIGS. 33 and 34 show an example of process for creating a model according to the third embodiment of the invention.

FIG. 35 shows a fault detection and classification function where a plurality of process devices are in use.

### DETAILED DESCRIPTION OF THE INVENTION

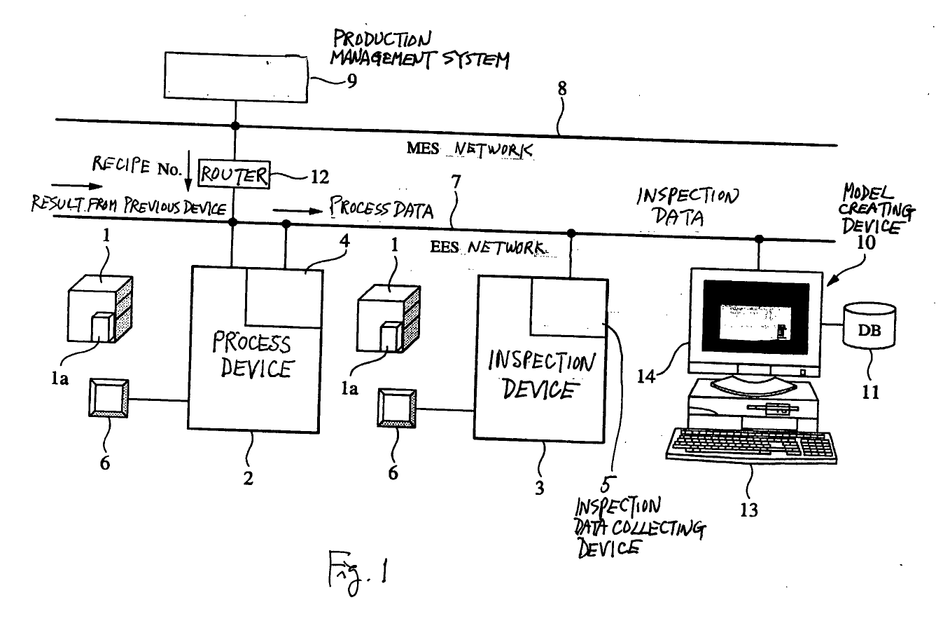

FIG. 1 shows a semiconductor production system including a model creating device 10 according to a first embodiment of this invention as well as a process device 2 and an inspection device 3 which are connected together by an EES (Equipment Engineering System) network 7 for exchanging process-related data more detailed than production management data at a fast rate. Although not shown in the drawing, other process devices and inspection devices that may be used at an earlier or later stage than the production process may be also connected to this EES network 7. This system also includes a production management system 9 inclusive of an MES (Manufacturing Execution System) and an MES network 8 connected thereto for transmitting production management data. The EES network 7 and the MES network 8 are connected to each other through a router 12 such that each device on the EES network 7 can be accessed also from the production management system 9 on the MES network 8.

With this semiconductor production system, a specified number of wafers (such as silicon wafers) to be processed are set inside a wafer cassette 1. They are not only thus transported as a unit between the process device 2 and the inspection device 3 as well as to and from the devices used beforehand and afterward but also processed together by these devices as a unit. The wafers thus set together inside the wafer cassette 1 eventually become wafers of the same lot.

A radio frequency identification (RF-ID) tag 1a, also referred to as a data carrier, is attached to the wafer cassette 1, serving to interact electromagnetically with a RF-ID read-write head 6 so as to exchange data therewith without contacting. The tag 1a may store data such as the lot ID (the identification information on the target products) and time at which it was discharged previously from an upstream device.

The process device 2 is for executing a specified process on the wafers and includes a process data collecting device 4 which serves to collect process status data in the order of time (in time sequence) while various process steps are being carried out by the process device 2. The process status data are data related to the status of the production process, and process steps are each one of the steps into which the whole process is divided. In general, it is advisable to divide a process into process steps where the nature of the process is changing because an effective result of analysis (such as process-quality model) can be obtained more easily in this way. If a single process of a same type continues for a relatively long time, this period may be divided into process steps. A process carried out by one device may be divided into a plurality of process steps or may be treated as one single process step.

The RF-ID read-write head 6 is connected to the process device 2 and serves to read and write data from and into the tag 1a on the wafer cassette 1 which contained the wafers set inside the process device 2. Examples of the data to be read include the lot ID and the time at which the wafers were taken output of the previous process device (on the upstream side). The process data collecting device 4 serves to collect not only the time read out from the tag 1a but also the time at which the wafers were set at the current process device 2. The difference between these times (“wait time” from the previous stage) may be calculated. If necessary, the head 6 writes into the tag 1a the time at which the wafers are taken output of the process device 2.

The process data collecting device 4 is provided with a communication function and may serve to output the collected process status data and the aforementioned wait time data to the EES network 7 in correlation with the lot ID. In the above, the “wait time data” may mean the data on the time of leaving the previous device and that of entering the current device or the difference between them.

The inspection device 3 is for inspecting the wafers processed in the process device 2 (such as a sputtering device) and outputting the inspection result data to the EES network 7. In the above, the inspection result data are the data on the result of the inspection, say, on the thickness and the quality of the film formed on the wafers. The RF-ID read-write head 6 is connected also to the inspection device 3, serving to read and write from and into the tag 1a on the wafer cassette 1 which contained the wafers set inside the inspection device 3. Examples of the data to be read out include the lot ID. An inspection data collecting device 5, which is contained in the inspection device 3, is also provided with a communication function and may serve to collect inspection result data and the lot ID and to output the inspection result data to the EES network 7 in correlation with the lot ID.

Although FIG. 1 shows an embodiment wherein one inspection device 3 is provided to one process device 2 and the wafers processed by this process device 2 are inspected by the corresponding inspection device 3, a semiconductor production process may be carried out such that specified processes are sequentially carried out by a plurality of process devices 2 and one inspection is used to inspect them. Such system structure will be described below as the third embodiment of the invention.

The production management system 9 serves to transmit to the process device 2 a recipe number (process specifying data) serving as production indicating data for specifying the kind of the process. The process device 2 is adapted to carry out specified processes corresponding to the received recipe number.

Lot numbers are used according to this embodiment of the invention since the production management is carried out in units of lots (groups of object articles). In the case of a system wherein an ID is provided to each wafer (or the object article), the IDs for the individual products and data are stored in correlation. In such a case, the IDs for the individual articles are used instead of the lot ID in the subsequent processing.

The model creating device 10 serves to collect the process status data, the wait time data and the inspection result data outputted from the two data collecting devices 4 and 5 and to store these data in a database 11 in correlation with the lot ID as the key.

From the point of view of hardware, the model creating device 10 may be an ordinary personal computer and the various functions of this device may be carried out by way of an application program on an operating system such as Windows (registered tradename). The database 11 which is made use of by the model creating device 10 may be provided on the hard disk which is internal to the computer serving as the model creating device 10 or in an external memory device. It may also be provided to another computer adapted to communicate with the model creating device 10.

The model creating device 10 is provided with an input device 13 such as a keyboard and an output device 14 such as a display. By operating on the input device 13, the user can manually input operator data, maintenance data and error data, and such manually inputted data are also stored in the database 11. The model creating device 10 is further provided with a function for creating a process-quality model on the basis of the process status data and the inspection result data connected by using the lot ID as the key as explained above. In addition, the model creating device 10 is provided with other functions such as the monitoring function for monitoring various data and the function for classifying and predicting various abnormalities and faults on the basis of a completed process-quality model. Details of these functions are explained below.

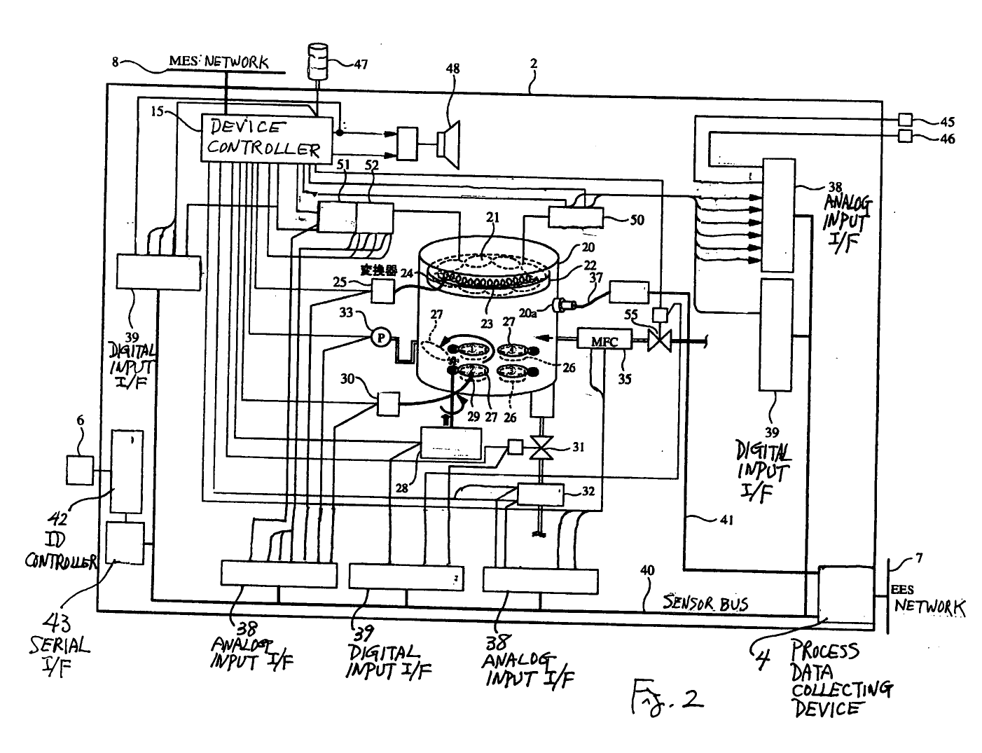

FIG. 2 shows the internal structure of the process device 2 in the case of a sputtering device for forming a thin film of a specified material on a wafer, being provided with a plasma chamber 20. The recipe number transmitted from the production management system 9 through the MES network 8 is received by a device controller 15. The device controller 15 is provided with a corresponding table between the recipe numbers and the processes to be actually carried out and is adapted to control the operations of the process device 2 according to the received recipe number.

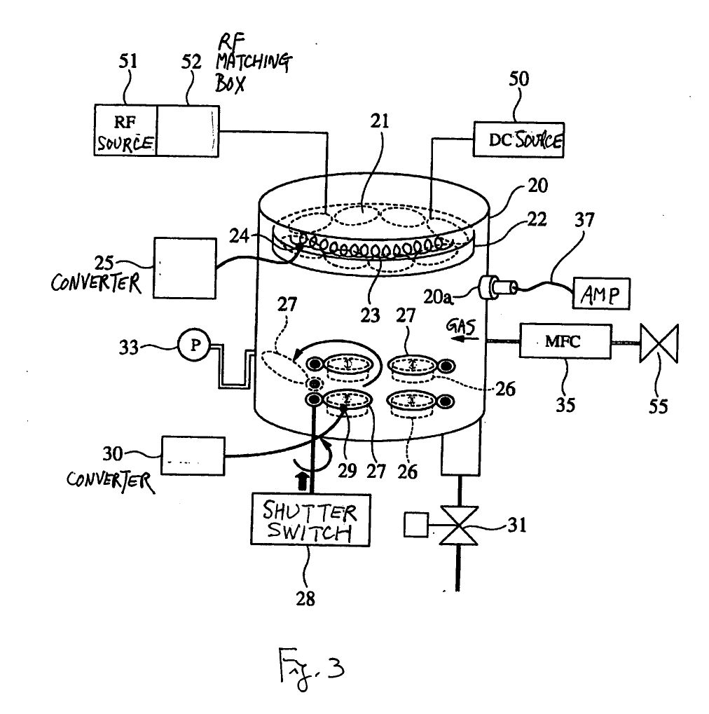

FIG. 3 is an enlarged drawing, schematically showing the internal structure of the plasma chamber 20 shown in FIG. 2 and some of the components connected thereto. Inside and at an upper portion of the plasma chamber 20 is a disc-shaped setting plate 22 such that a specified number (eight according to the illustrated example) of wafers 21 can be attached to its lower surface. A heater 23 is contained inside this setting plate 22, provided with a thermo-couple 24. The output from the thermo-couple 24 is converted to temperature data by means of a converter 25 and transmitted to the device controller 15. The switching of the heater 23 or the heater temperature is controlled on the basis of the temperature data such that the temperature of the setting plate 22 is kept at a specified level. The setting plate 22 is also connected to the positive terminal of a DC power source 50 such that the wafers 21 will be positively charged. The output from an RF (radio-frequency) power source 51 is also applied to the setting plate 22 through an RF matching box 52.

Targets 26 are set at lower positions inside the plasma chamber 20, connected to the negative electrodes (not shown) of a DC power source 50. According to the illustrated example, there are four targets 26 disposed inside the plasma chamber 20 such that a plurality of layers can be formed by a series of processes. A shutter 27 is provided above each of the targets 26, adapted to be opened and closed by means of a shutter switch 28. The material of each target 26 will not become attached to the wafers 21 if the corresponding shutter 27 is in the closed condition but will become attached to the surfaces of the wafers 21 to form films if the corresponding shutter 27 is in the open condition. The switch 28 for the shutters 27 is controlled by a control command from the device controller 15. The temperature of each target 26 is detected by a thermo-couple 29 and the temperature data thus obtained are transmitted to the device controller 15 through a converter 30.

The interior of the plasma chamber 20 is connected to a vacuum pump 32 through a main valve 31. The interior of the plasma chamber 20 can be maintained at a desired degree of vacuum or at a specified pressure by opening and closing the main valve 31 or adjusting its opening while the vacuum pump 32 is operated. This control is effected by way of a command from the device controller 15 on the basis of the chamber pressure detected by a pressure gauge 33. A controller for carrying out APC (Auto Pressure Control) according to a command from the device controller 15 may be provided apart from the device controller 15. Argon gas is introduced into the plasma chamber 20 for sputtering through a gas supply valve 55 and a mass flow controller (MFC) 35. The device controller 15 serves to control the opening and closing of the gas supply valve 55 and to specify a set value for the mass flow controller 35. When a film-forming process is carried out, the gas supply valve 55 is firstly opened to supply the argon gas into the plasma chamber 20. At this moment, the flow rate of the argon gas is controlled according to the set value and the pressure inside the plasma chamber 20 becomes controlled to a set value as the main valve 31 is controlled. The shutter 27 is opened under this condition such that the material of the target 26 is caused to be attached to the wafers 21 to form thin films. The shutter 27 is closed thereafter and the gas supply valve 55 is closed to complete the process for forming one layer.

A plasma monitor 37 is attached to a view port 20a on a side wall of the plasma chamber 20 such that the conditions of the plasma being generated inside can be detected.

Operations of each device connected to the plasma chamber 20 are carried out by a control command from the device controller 15. Data or signals (set values and ON/OFF conditions) indicative of such control commands and the measured data (such as temperatures, pressure values, voltage values and current values) related to the conditions of operations are transmitted through an analog input interface 38 or a digital input interface 39 and a sensor bus 40 and obtained by the process data collecting device 4. The detection output of the plasma monitor 37 is transmitted through an Inthernet (registered tradename) line 41 to be received by the process data collecting device 4. The lot ID and the time of leaving the device of the previous stage and the time of entering are acknowledged by an ID controller 42 on the basis of the data read out by the RF-ID read-write head 6 and this is transmitted through a serial interface 43 to the sensor bus 40 to be received by the process data collecting device 4.

The process device 2 is further provided with a temperature sensor 45 and a humidity sensor 46 for measuring the environmental temperature and humidity. The data detected by these sensors 45 and 46 are also collected by the process data collecting device 4.

A signal tower (light) 47 is also provided to the process device 2 for informing the workers in the neighborhood of its operating conditions (in operation, stopped, presence or absence of abnormality, etc.) The control on the lighting of this signal tower 47 is also carried out by a control command from the device controller 15. This control command to the signal tower 47 is transmitted also to the process data collecting device 4. At the end of a process, the device controller 15 may cause a chime to be sounded. Such a signal for the completion of a process is also transmitted to the process data collecting device 5.

Thus, the process data collecting device 4 serves to collect all sorts of data generated by the process device 2 and to output them to the EES network 7. The kinds of data collected thereby are not limited to what has been described above. The invention does not impose any particular limitation regarding the kinds of data to be collected. Although the invention was described above with reference to a plasma chamber 20 capable of using a plurality of targets, it also goes without saying that the invention is applicable also to a plasma chamber adapted to accommodate only one target (for forming only one kind of film). Moreover, the process device 2 need not be a sputtering device. It may also be an etching device, a CVD device or a device of many different kinds.

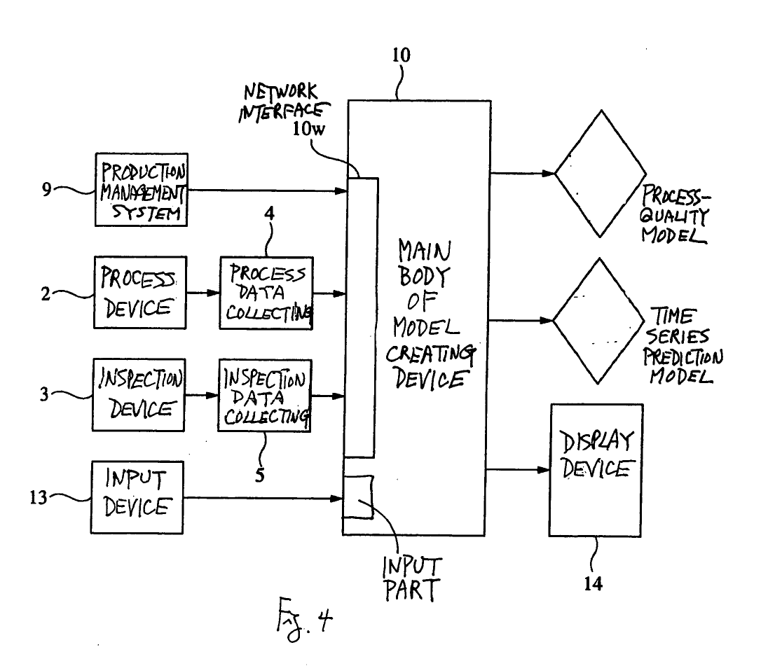

FIG. 4 is a drawing that shows the connection among the devices forming the system of FIG. 1 from the point of view of data exchange. The process status data, the lot ID and the wait time data obtained by the process device 2 are transmitted towards the model creating device 10 through the process data collecting device 4. The process status data, the lot ID and the wait time data obtained by the process device 2 are transmitted towards the model creating device 10 through the process data collecting device 4. The model creating device 10 is provided with a network interface 10w for connecting to the EES network 7 and inputs these data through an input part of the network interface 10w (a first input part for inputting the process status data, a second input part for inputting the inspection result data, a third input part for inputting ID data of a target object for specifying a unit target object and a fourth input part for inputting data on the wait time). The model creating device 10 inputs also data transmitted from the production management system 9 (such as recipe numbers) through the network interface 10w. Data of all sorts are also transmitted to the model creating device 10 from the input device 13 through the input part (a fifth input part for inputting abnormality data and a sixth input part for inputting supplemental process data) which is a human-machine interface (HMI: such as the keyboard connected to the model creating device 10). The input method for each of such data to the model creating device 10 is not intended to limit the scope of the invention. Inputs through wireless communication and inputs through a memory medium may be conveniently utilized.

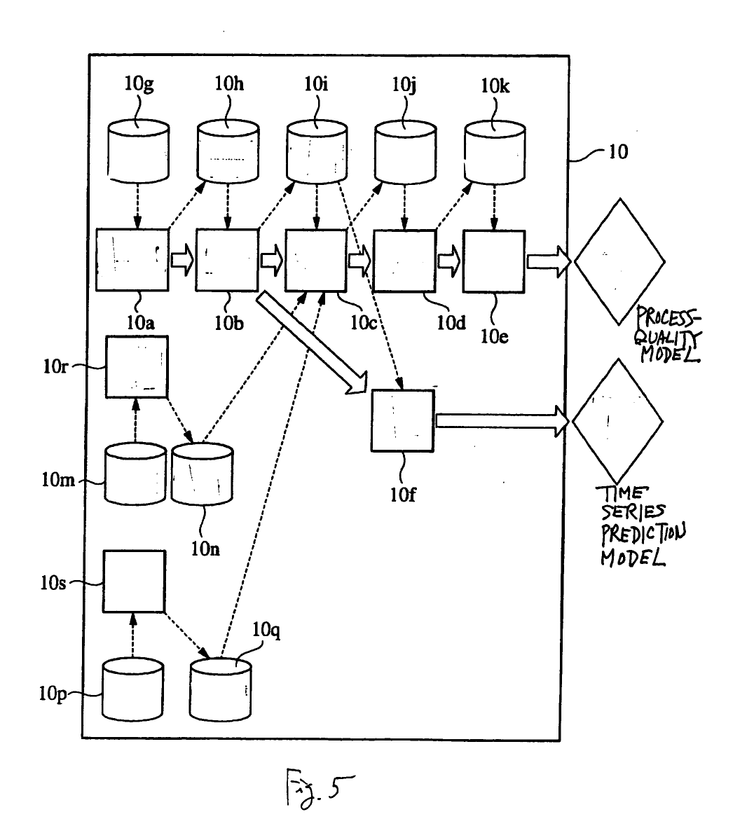

FIG. 5 shows the internal structure of the model creating device 10. As schematically illustrated, the model creating device 10 includes the following processing parts (functions) through an application program to be operated on its operating system: a step correlating part 10a, a characteristic extracting part 10b, a data combining part (an inspection result correlating part) 10c, a data filter part 10d, an analyzer part 10e, an inspection data editing part 10r, a time series analyzer part 10f and a fault data editing part 10s. These parts can be each realized by a dedicated hardware circuit.

In addition, a primary data memory (a memory for storing process status data) 10g, a step data memory 10h, a process characteristic quantity memory 10i, a general data memory 10j, an analysis data memory 10k, an inspection data memory 10m, an edited inspection data memory 10n, a fault data memory 10p and an edited fault data memory 10q are provided for storing data to be accessed by each of the processing function parts. These memories are provided in the database 11 but may also be provided to a memory part of the model creating device 10 or a hard disk or in the memory part of another computer that communicates with the model creating device 10.

The model creating device 10 may be structured differently, comprising a client computer that is connected to the EES network 7 and serves to process communications with the process device 2 and the inspection device 3 and that of the human-machine interface and a server computer that serves to communicate with this client computer and is provided with the functions of the various parts described above. Alternatively, the model creating device 10 may be disposed separately at a remote place, communications being made with a communication line such as the Internet with the process devices and the lines at a production site. In summary, many other computer structures are possible for realizing the model creating device 10 of this invention.

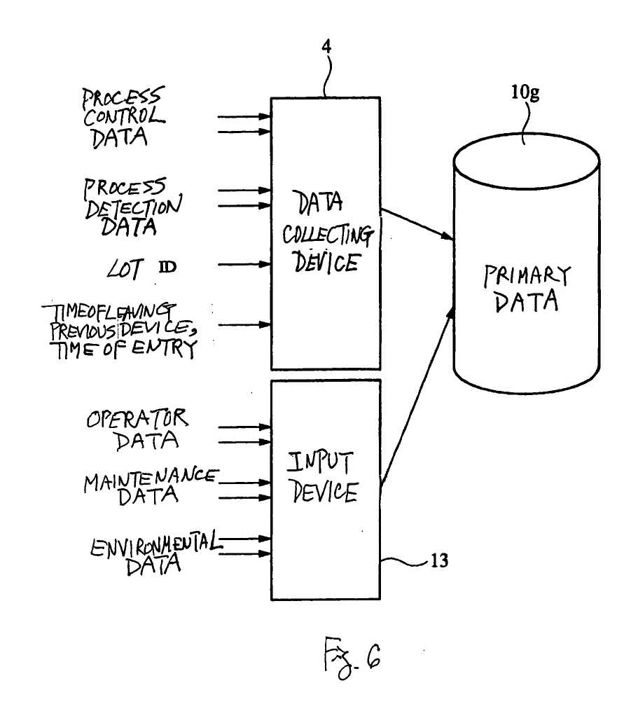

FIG. 6 shows an example of data to be inputted to the model creating device 10. The primary data memory 10g stores the data collected from the process device 2 through the process data collecting device 4 and the data inputted by the user operating on the input device 13. Of the data sent from the process collecting device 4, the process status data and the wait time data (representing the period from the time of leaving the previous device until the time of entering the current device) are stored in the primary data memory 10g, each correlated with the lot ID.

In the above, the process status data include process control data and process detection data. The process control data include various control data outputted by the device controller 15 of the process device 2 and the status of various control signals outputted by the device controller 15. Examples of these control data and control signals include the set value for the gas flow rate, the set DC power value for the DC power source 50, the ON/OFF condition of the main valve 31, the chime at the end of the process, the opening of the shutters 27, the opening of the argon gas supply valve 55 and the lighting of the signal tower 47.

The process detection data are obtained by the various detectors of the process device 2 and include, for example, the power of the traveling waves from the RF power source 51, the power of the reflected waves of the RF power source 51, the bias voltage of the RF power source 51, the pressure inside the plasma chamber 20, the flow rate of the gas, the wafer temperature, the quantity of plasma light (Ar and O₂), the DC power (or voltage and current) of the DC power source 50, the ambient temperature measured by the temperature sensor 45 and the ambient humidity detected by the humidity sensor 46.

According to the illustrated example, the control signals outputted from the device controller 15 are also treated as data and transmitted to the model creating device 10 by network communication but an output line for the control signals may be branched off such that the control signals are directly transmitted as signals to the model creating device 10. If this is done, the status of the control signals is converted in the form of data by the model creating device 10 in correlation with the time and stored in the primary data memory 10g.

Operator data, maintenance data and environmental data are inputted from the input device 13. These data are also stored in the primary data memory 10g. The operator data include the operator ID, the device ID and start/end classifications. The user inputs these data from the input device 13 when starting and ending each work. The maintenance data include data on pump recondition and exchange of target material. The operator registers these data whenever such work is completed. In other words, whenever a pump within a device is inspected, cleaned or reconditioned, the details of the work is inputted from the input device 13. If the target material is exchanged, the name of the material that has been exchanged, its lot number and the date of the exchange are inputted from the input device 13. The environmental data include special weather data that can become a factor affecting the quality of the products (such as hurricanes and thunderbolts) and the magnitude in the case of an earthquake. Whenever such data are present, the operator records them together with the date and the device ID.

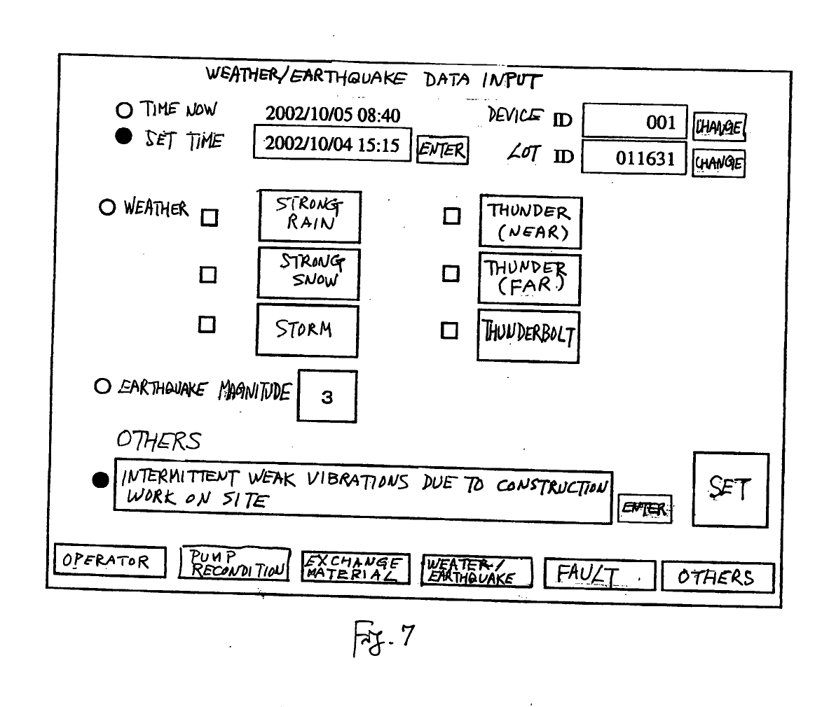

FIG. 7 is an example of input screen of weather/earthquake data to be displayed on the display device 14. The operator operates the input device 13 such as a keyboard or a pointing device by using such an input screen to input required data. FIG. 7 is not intended to limit the data to be inputted. Any other extra data are allowed to be inputted. If the selectable branches are preliminarily determined, an input can be made easily, for example, by pointing a specified area on the display screen of the display device 14. If the selectable branches are not predetermined, the input device 13 such as a keyboard may be used to input desired test data. Such voluntarily inputted data may be registered as a new selectable branch so as to be displayed as one of selectable branches from the next time. This feature is useful especially in the semiconductor production processes where defective products are frequently produced by an unpredicted cause and consideration of such new cause is considered useful in a new analysis such as when a process-quality model is created.

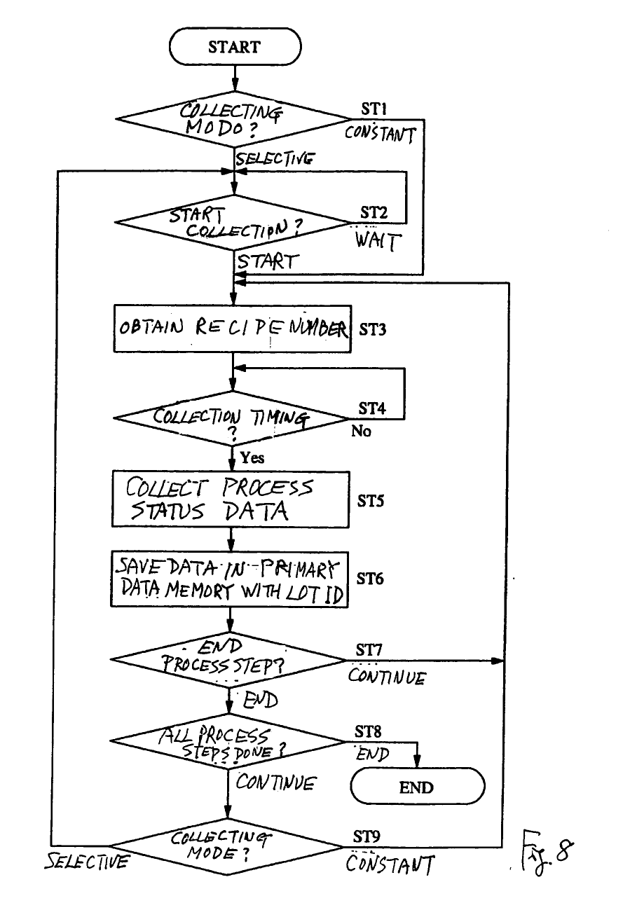

FIG. 8 is a flowchart for explaining the processes by the process data collecting device 4 for collecting data and registering data in the primary data memory 10g. In this illustrated example, two modes of operations are prepared which are for convenience referred to as the “selective” collecting mode and the “non-selective” (or “constant”) collecting mode.

The selective collecting mode is the collecting mode wherein data are collected selectively only while one or more of specified process steps are being carried out. The constant collecting mode is the collecting mode wherein data are collected throughout a period of all process steps carried out by the process device 2 on a specified product (such as a wafer). If there is a wait period between process steps, such wait period is also included. In either of these collecting modes, data sampling is carried out at a fixed frequency (such as once per 100 msec) while data are being collected.

Before starting the process, the operator decides which of the modes is to be selected, say, by using the input device 13 or by using a selection switch provided on the process data collecting device 4. The non-selective mode is provided because not only every process step but also even the wait condition can potentially have an influence on the quality of the product.

When a process on a certain product is started by the process device 2, the process data collecting device 4 firstly determines which of the modes has been selected (Step ST1). If the selective collecting mode has been selected, the program waits until it can be judged that the process has been started and the collection of the data should be started (Step ST2). Such judgment may be made, for example, when the control command to the main valve has been switched from OFF to ON. It goes without saying that many other conditions can serve as the condition for starting the collection of data.

If the constant collecting mode has been selected or if the collection of data is started in the selective mode, the process data collecting device 4 firstly obtains recipe number which was outputted from the production managing system 9 and is currently being processed (Step ST3). A set of process status data is collected (Step ST5) when the collection timing is right (Step ST4).

Next, the process data collecting device 4 adds the lot number and the date data to the obtained data and transmits the obtained data to the model creating device 10 which serves to store the transmitted data in the primary data memory 10g (Step ST6). The date data may be added automatically based on the internal clock of the process data collecting device 4 when the data are received or may be added by the model creating device 10.

If the process step is continuing, the program returns to Step ST3 (Step ST7). At the end of each process step, it is judged whether all process steps have been completed (Step ST8). If all process steps have been completed, the program is ended. If another process step is continuing, the collecting mode is checked (Step ST9). If it is in the selective mode, the program returns to Step ST2 and waits for the start of next collection. If it is in the constant mode, the program returns to Step ST3 to continue the collection of data. Process status data of many different kinds are thus collected in time series.

The process data collecting device 4 also serves to correlate the wait time data from the time of leaving the previous device with the lot ID, making at least one transmission to the model creating device 10 while the products of that lot ID are being processed. The model creating device 10 stores the transmitted wait time data in the primary data memory 10g.

As shown in FIG. 7 as an example, any data inputted through the input device 13 such as any date and time specified by the operator can be inputted. In other words, the fact that a certain work was done can be recorded like a daily log such that such a fact can be later examined to check whether or not such a work had any effect on the quality of the product.

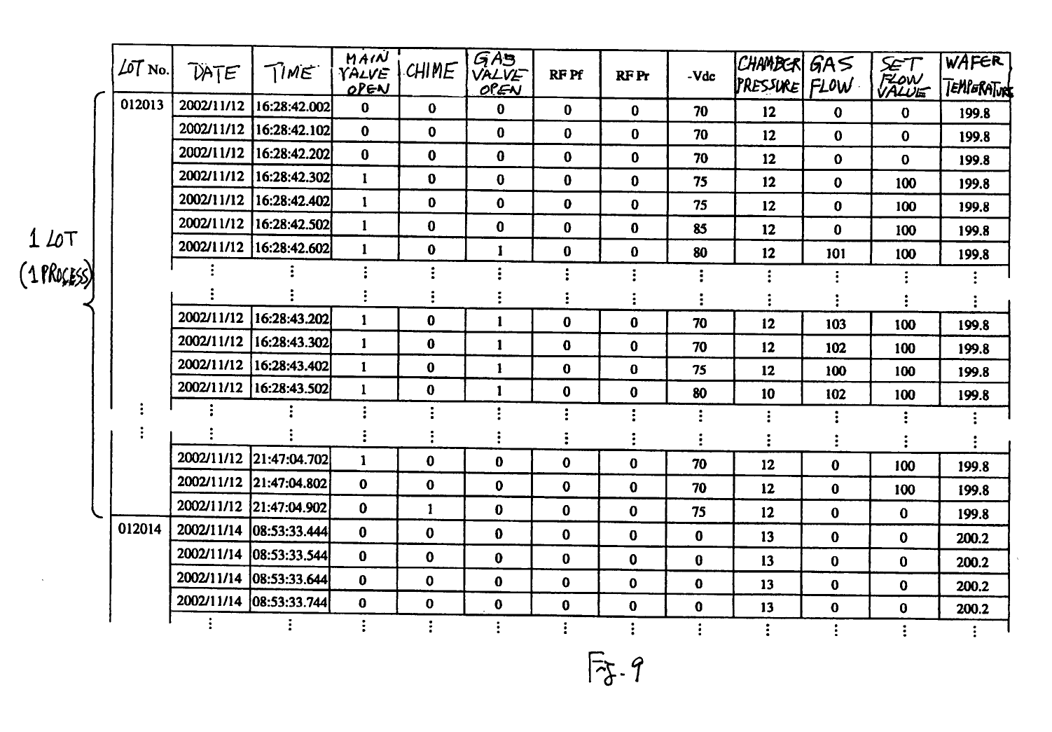

FIGS. 9-11 show an example of the structure of data stored in the primary data memory 10g. For convenience, FIGS. 9 and 10 are shown as separate graphs but they represent the same lot number.

The inspection data memory 10m shown in FIG. 5 stores the inspection result data collected by the inspection data collecting device 5 from the inspection device 3. The inspection result data include data for identifying the object matter such as the date and time of inspection, the device ID, the lot ID and the wafer ID as well as data related to the inspection result such as the film thickness data and film matter quality data.

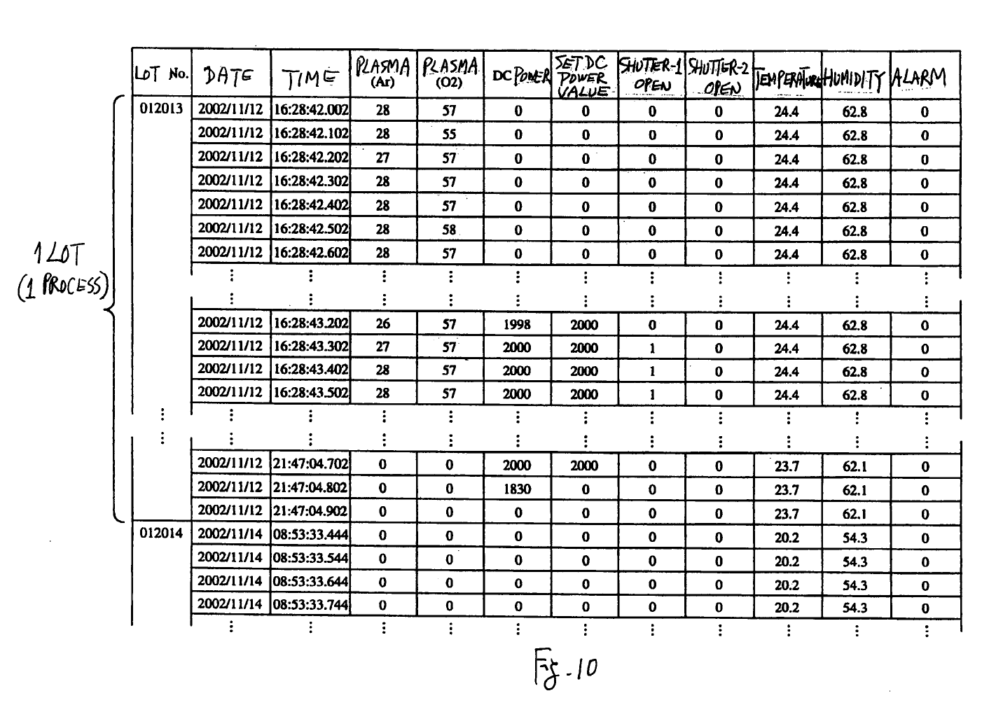

FIGS. 12A and 12B show a method of inspecting thickness of membranes, as an example of inspection method. According to the illustrated example, the process device 2 is adapted to form film layers as shown in FIG. 12A by incorporating a plurality of targets 26 although the number of the targets and the number of the formed film layers do not necessarily match. The inspection device 3 according to the illustrated embodiment measures the film thickness for each layer, capable of measuring thickness of up to four layers. The thickness of each layer is measured at a plurality of positions. According to the example shown in FIG. 12B, the measurement is taken at the center and at four peripheral points, or at a total of five different points P.

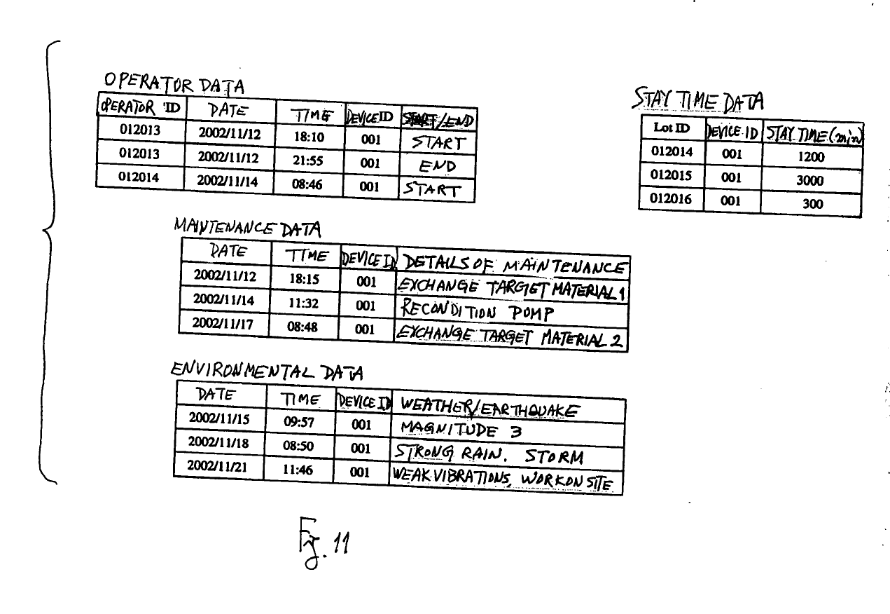

FIG. 13 shows an example of the structure of data stored in the inspection data memory 10m. Since films corresponding to only two different materials are formed on the base board according to this example, data only related to Layer 1 and Layer 2 are stored.

The fault data inputted by the operator operating on the input device 13 are stored in the fault data memory 10p shown in FIG. 5. The fault data include the time of the fault, the device ID, details of the fault, the lot ID and other inputted data.

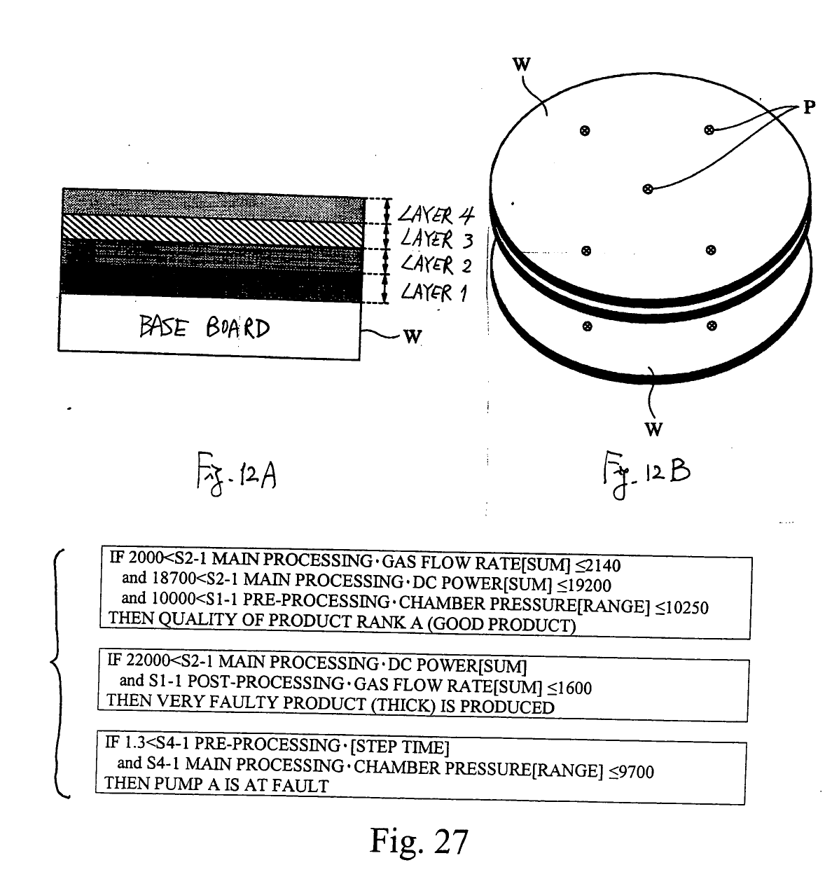

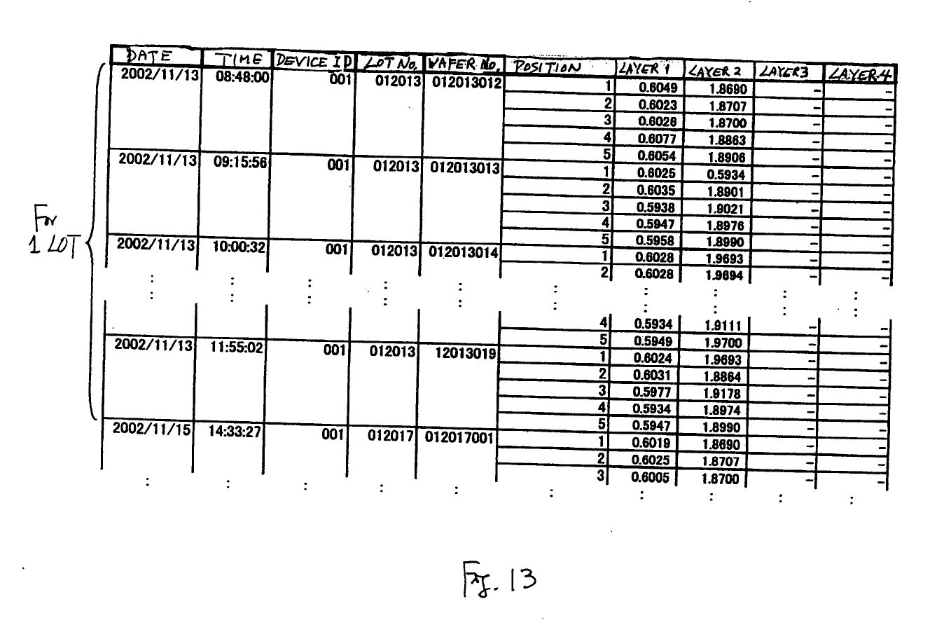

FIG. 14 is an example of input screen of fault data to be displayed on the display device 14. Such data are inputted by operating the input device 13 such as a keyboard or a pointing device. The data and time data may be inputted selectively either automatically as the current time and date based on a inner clock of the device or the set time and data inputted by the operator. FIG. 15 shows an example of the structure of the data stored in the fault data memory 10p.

As explained above, a large amount of data of many kinds are inputted to the model creating device 10 from each device and stored in appropriated memories. The model creating device 10 carries out specified processes on the basis of these data to create a process-quality model. Details of this process are explained next.

To start, the data of different kinds stored in the primary data memory 10g (process status data, wait time data, operator data, maintenance data and environmental data) are called to the step correlating part 10a to establish correspondence with the process steps. If the process steps recognized by each device of the process data collecting device 4 and the model creating device 10 are divided in the same way so as to have common divided process steps the process status data and the wait time data may be preliminarily correlated with the process steps when the data are collected by the process data collecting device 4. If this is the case, the processes by the step correlating part 10a are carried out only on the other data. The model creating device 10 may divide process steps differently from the division by the process data collecting device 4.

After the data stored in the primary data memory 10g are correlated with the process step, this result is stored in the step data memory 10h.

Time being counted from the start of the process, if the time to start each process step is preliminarily determined, correlation with process steps may be established by the step correlating part 10a on the basis of the time data.

In what follows, a method of correlating with steps on the basis of time-series changes of the process status data will be explained. A process step may be written, for example, in the form with a pre-processing (PRE), a main processing (MAIN) and a post-processing (POST). The main processing may be further divided into a plurality of steps, if it is appropriate.

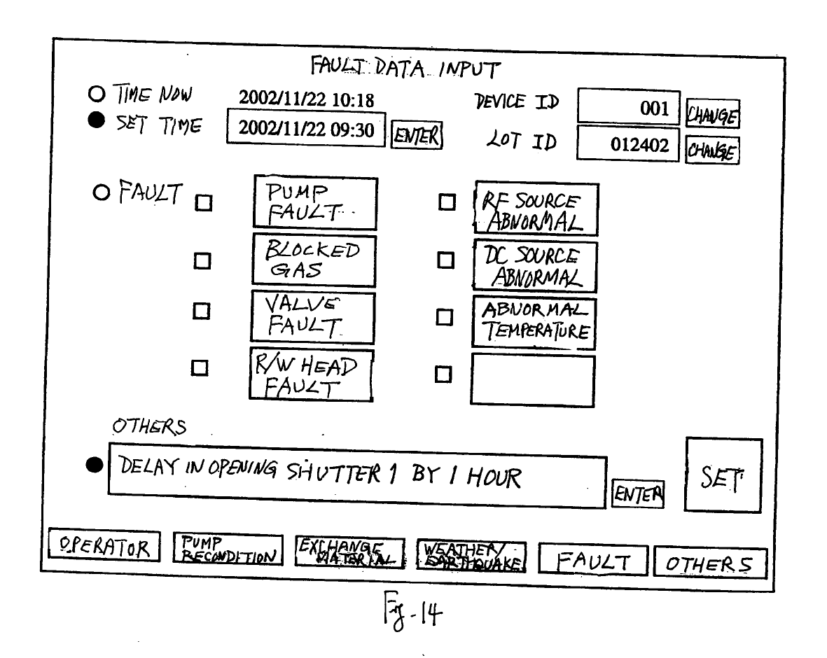

FIG. 16 shows an example of correlation with steps in the case of a film-forming process. When a layer of film is formed on a wafer 21, the argon gas supply valve 55 is initially opened as a pre-processing to establish an argon atmosphere inside the plasma chamber 20. Next, as a main processing, the shutter 27 is opened in this argon atmosphere to sputter the material of the target 26 to form a film of a desired kind on the wafer 21, the shutter 27 being closed thereafter. As the post-processing thereafter, the argon gas supply valve 55 is closed after a specified length of time has passed since the shutter 27 is closed. A plurality of layers of films are formed by repeating such a process comprising a pre-processing, a main processing and a post-processing by changing the target 26. In FIG. 16, “S4-1”, for example, means the first film-making process by using the fourth target.

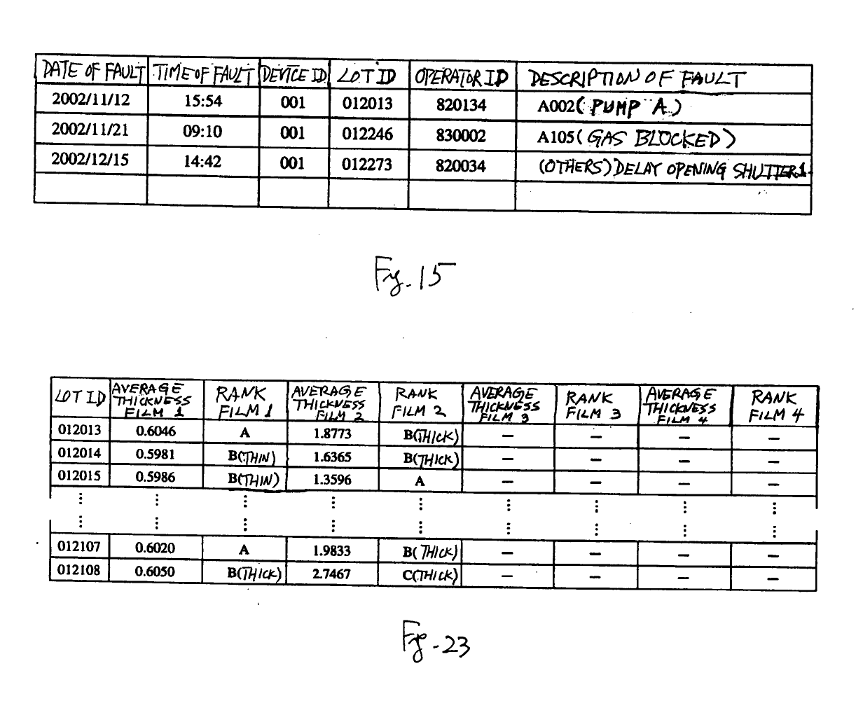

FIG. 17 shows how the timing for starting and ending a step is determined by the step correlating part 10a from the change in data. This timing is determined by using an appropriate signal selected from the following: (1) rise and fall of digital (binary) signal (as shown in FIG. 17A), (2) rise and fall of analog (numerical) signal (as shown in FIG. 17B), (3) period of a specified level of a digital (binary) signal (as shown in FIG. 17C), and (4) period of a specified level of an analog (numerical) signal (as shown in FIG. 17D). For analog signals, the timing for the switching is determined according to an appropriately defined threshold value.

The rise and fall of the signals shown in FIGS. 17A and 17B need not refer to the same signal, forming a pair to indicate the start and the end of a step. They may refer to different signals forming such a pair to indicate the start and the end of a step. In the case of FIGS. 17C and 17D, the period during which each signal is at a specified level itself becomes the step. The start and the end of a process step may be conditioned on the result of a logical calculation on the data of a plurality of kinds.

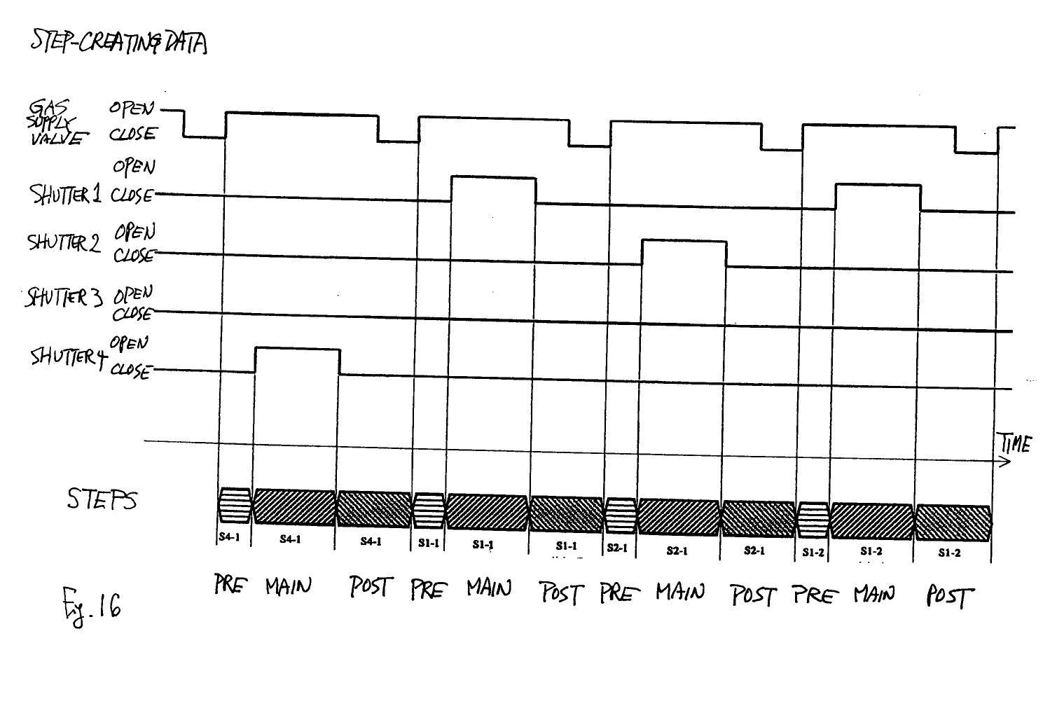

FIG. 18 shows an example of the start and the end of a process step where one of the targets is used to form a layer of thin film. The process step for the pre-processing in this case is the period from the rise of the binary control data for the argon gas supply valve 55 indicating the opening of the valve until the rise of the binary process control data indicating the opening of the shutter. The process step of the main processing is the period during which the control data for the shutter 27 remain on the high level. The process step of the post-processing is the period from the fall of the control data of the shutter 27, indicating the closing of the shutter 27, until the rise of the control data of the argon gas supply valve 55, indicating opening of the valve to start the pre-processing for the forming of the next layer of thin film after the valve is closed once during the post-processing. The conditions for starting and ending each process step may be inputted to the model creating device 10 by the operator using the input device 13 and stored in the step correlating part 10a.

The end of the pre-processing may be prescribed, not by the rise of the control data of the shutter 27 (indicating the opening of the shutter), but by the rise of the control data of the DC power (process detection data which are analog (numerical data)) beyond a specified threshold value (the start of power supply from the DC power source 50 to the setting plate 22). The period for the main processing may be defined, not as the period during which the control data of the shutter 27 remain HIGH, but as the period during which the control data of the DC power source remain over a specified threshold value. The start of the post-processing may be prescribed not by the fall of the control data of the shutter 27 (indicating the closing of the shutter), but by the fall of the control data of the DC power source below a specified threshold value (indicating the end of the DC power supply).

The opening of the shutter 27 and the starting of the supply of DC power are nearly simultaneous and the closing of the shutter 27 and the end of the DC power supply are again nearly simultaneous. The period during which the shutter 27 remains open and during which the DC power is being supplied corresponds to the period during which plasma is being generated to contribute to the formation of the film. Thus, the pre-processing step is the period before plasma is generated, the main processing step is the period during which plasma is being generated and the post-processing step is the process step after the plasma generation is stopped.

Process steps are generally set according to the changes in the substance or nature of the process. If a particular process step such as a main processing lasts for a long time, the process step may be further divided according to a preset condition without regard to any changes in the process status data.

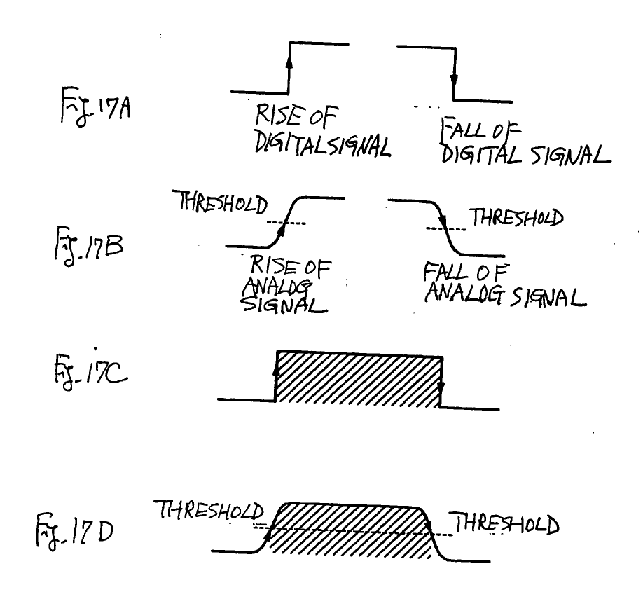

FIG. 19 shows examples of dividing a process step further into smaller steps. FIG. 19A shows an example of equally dividing a process step based on changes in process status data into smaller steps. FIG. 19B shows an example of dividing a process step into smaller steps of an equal time duration. In this case, the last of the divided steps generally has a different time duration. FIG. 19C shows an example of dividing a process step into smaller steps of individually different time durations.

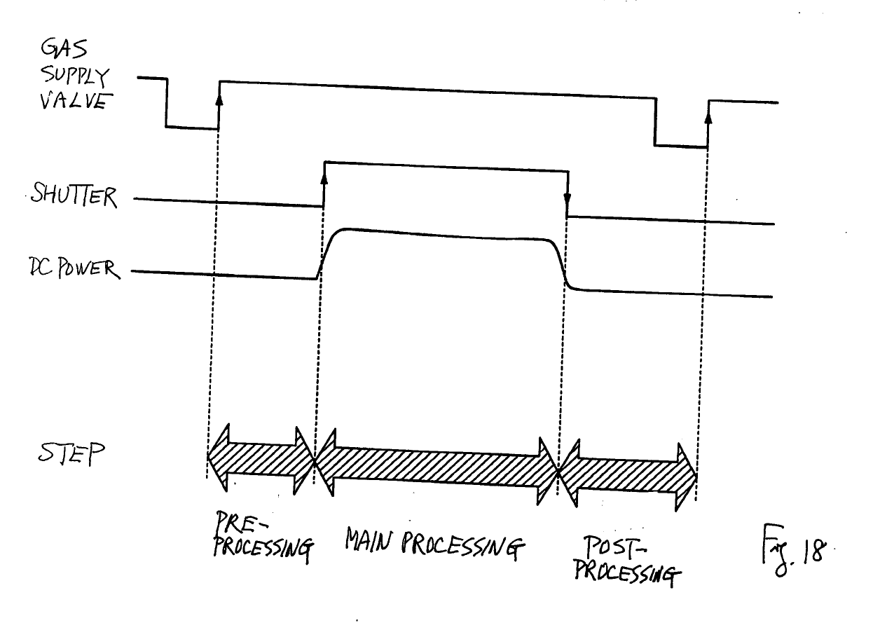

FIGS. 20 and 21 show an example of the structure of data stored in the step data memory 10h. The rows of items such as “S4-1 pre-processing” and “S4-1 main processing” are step data. For the convenience of description, a portion of process status data is omitted but the actual data are of the structure shown in FIGS. 9 and 10 with step data added thereto. The data which are stored as step data are “1” and “0” where “1” means that it belongs to that step. For example, the data row for Lot No. 012013, collected on Nov. 12, 2002 at 21:47:04:702 has “1” for “S1-2 post-processing” and this means that the process condition data collected at this time on that day are data that belong to the step of “S1-2 post-processing”.

Although not illustrated, the operator data, maintenance data, environmental data and wait time data shown in FIG. 11 are also stored in the step data memory 10h.

Next, numerical data within the data of all sorts stored in the step data memory 10h are called to the characteristic extracting part 10b where a characteristic quantity is extracted for each step and the extracted process characteristic quantity data are stored in the process characteristic quantity memory 10i. As for the wait time data, since they are not time series data although they are numerical data, and since they are data generally attached to a processing at a specified process device, they are directly stored in the step data memory 10h as a characteristic quantity.

Candidates of characteristic quantities to be extracted include arithmetic mean, maximum minimum, standard deviation, cumulative sum, range (difference between maximum and minimum), geometrical mean, harmonic mean, trimed, first quartile, third quartile, skewness, median, acceleration, kurtosis and step time. It goes without saying that other quantities may be used as characteristic quantity and that not all of those mentioned need to be extracted The characteristic extracting part 10b serves to search the column of step data from the obtained data, to extract data rows having “1” for each step data and to obtain all characteristic quantities to be extracted for numerical data having “1” for the same step data.

For example, process characteristic quantities are extracted regarding average, maximum, minimum, standard deviation, cumulative sum, range, etc. of the gas flow rate belonging to Step “S4-1 Pre-Processing” of FIG. 16, average, maximum, minimum, standard deviation, cumulative sum, range, etc. of the DC power belonging to Step “S4-1 Pre-Processing”, and thereafter similarly regarding those of pressure inside chamber, wafer temperature, plasma (Ar) light quantity, etc. belonging to Step “S4-1 Pre-Processing”.

Regarding Steps “S4-1 Main Processing” and “S4-1 Post-processing”, too, process characteristic quantities of the same kinds are extracted for the same data items as regarding Step “S4-1 Pre-Processing”. Process characteristic quantities of the same kinds are further extracted for the same data items regarding each of the pre-processing, main processing and post-processing of S1-1, S2-1 and S1-2.

As a result, characteristic quantities of kinds common to each item of process status data (or those having numerical data) for each step are extracted. All these extracted characteristic quantities are correlated for each lot ID to create process characteristic quantity in a table form and stored in the process characteristic quantity memory 10i.

In order to improve the accuracy of the process-quality model, an unrestricted input is allowed through the input device 13, as explained above. Thus, process engineers and operators are free to input any information that may be considered to influence the quality of the products as soon as they become aware of it and such additional information can be incorporated into the data to be analyzed.

Semiconductor products are produced through hundreds of different kinds of work processes. During a period in such a production process after wafers are processed by one device until they are taken into another device for the next process, the wafers are usually exposed to air and hence their surfaces are likely to become oxidized and some particles are likely to become attached to their surfaces. This is why the aforementioned wait time data are included in the data to be analyzed because they are sure to influence the quality of the product.

Data of various kinds stored in the aforementioned inspection data memory 10m shown in FIG. 5 are called to the inspection data editing part 10r and the data edited thereby are stored in the edited inspection data memory 10n.

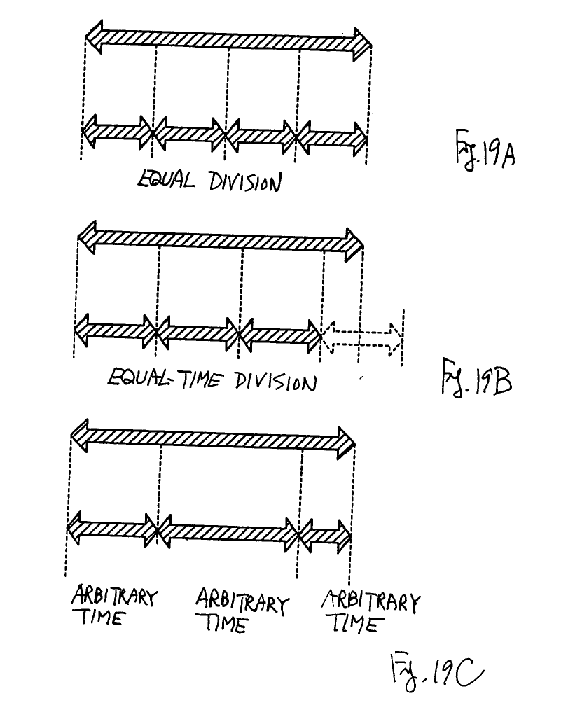

FIG. 22 shows the meaning of the internal data of the edited inspection data memory 10n. As shown in FIG. 22A, if there are a plurality of inspection result data of the same item corresponding to a certain object of inspection, inspection result data in units of lots or wafers are created by an averaging method or some other method. Thereafter, the product quality is ranked according to a standard reference table such as shown in FIG. 22B. In the illustrated example, the ranking is done in terms of the film thickness, dividing the normal range (for “good” products) into A, B and C according to the average film thickness and the defective products are further classified, depending on whether they are very or only slightly defective and whether they are too thick or too thin.

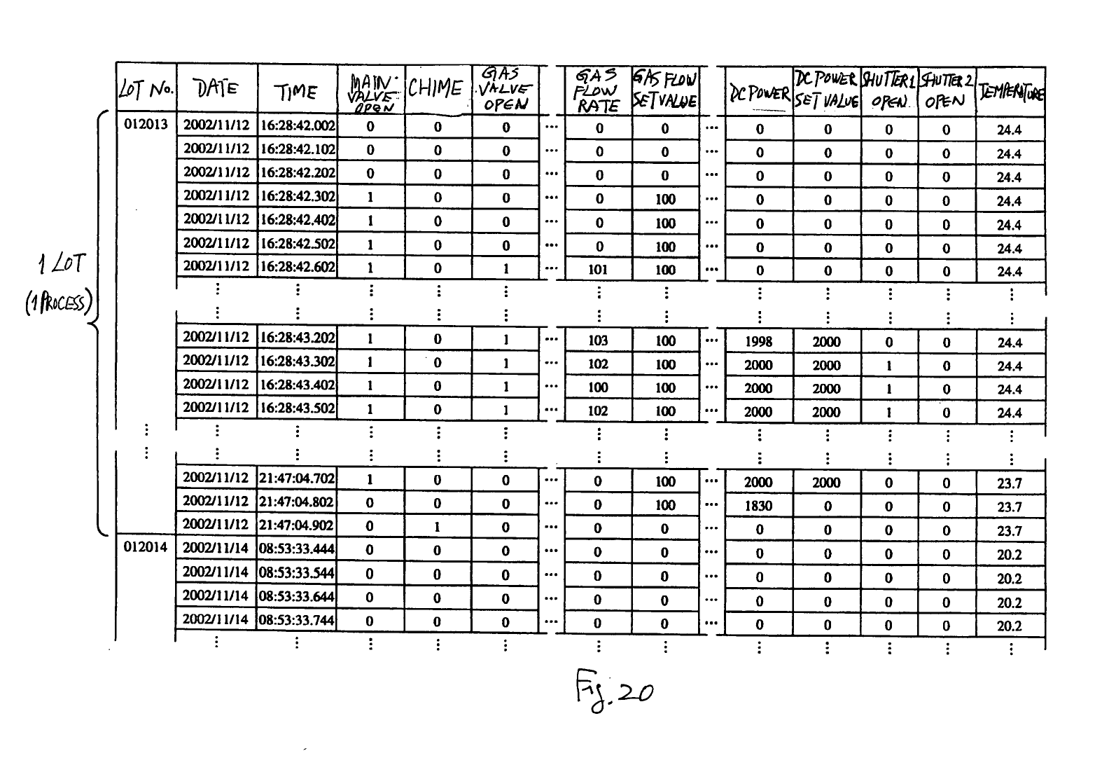

FIG. 23 is an example of the structure of edited inspection data obtained by the inspection data editing part 10r and stored in the edited inspection data memory 10n. Average film thickness and rank in thickness (product quality) are stored for each film (layer) in units of lot IDs.

Data of various kinds stored in the fault data memory 10p shown in FIG. 5 are called to the fault data editing part 10s and edited thereby. The edited fault data are stored in the edited fault data memory 10q.

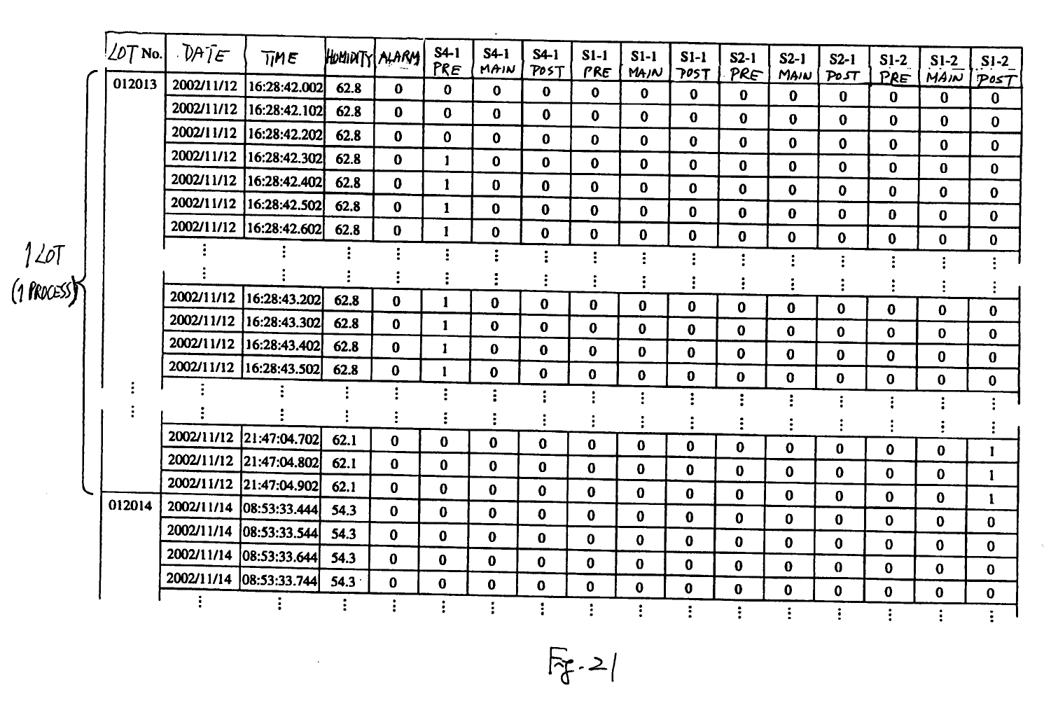

FIG. 24 is an example of a table with which the fault data editing part 10s is provided, showing the correspondence between the details of input related to faults and the fault codes. The fault data editing part 10s serves to codify fault data inputted through the input device 13. If fault data are already codified data, such data are directly registered in the table and such a code is directly used when a fault of the same kind has occurred.

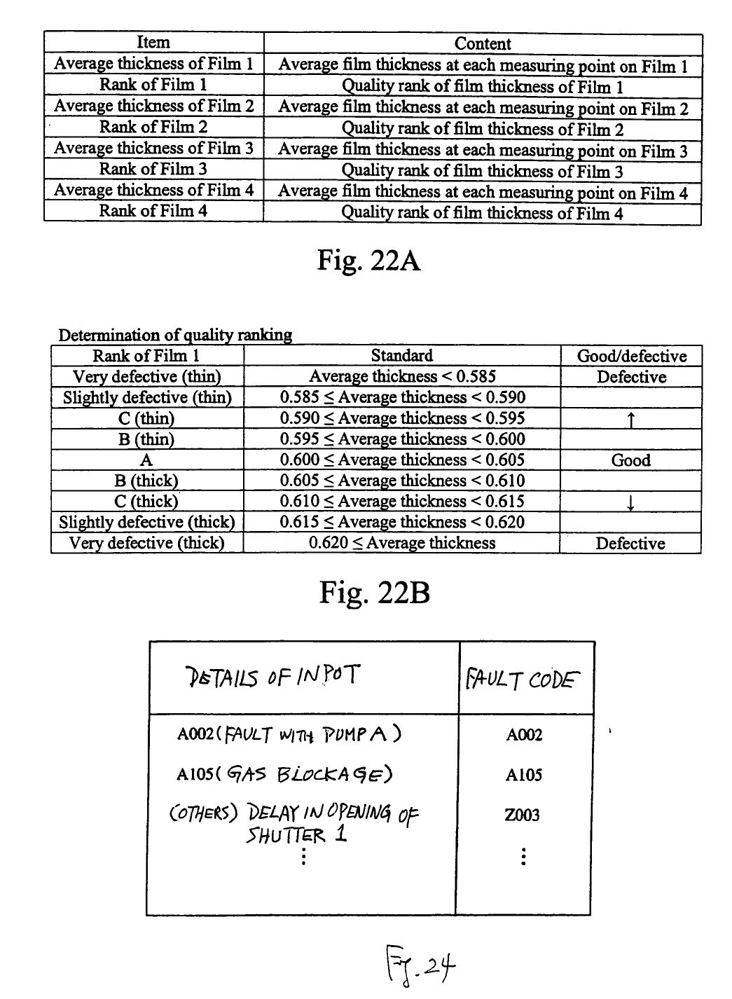

FIG. 25 is a table showing an example of internal structure of the edited fault data memory 10q. In this example, codified data of various kinds (data of fault, time of fault, lot ID, device ID, operator ID and fault code) are summarily stored in units of lot IDs.

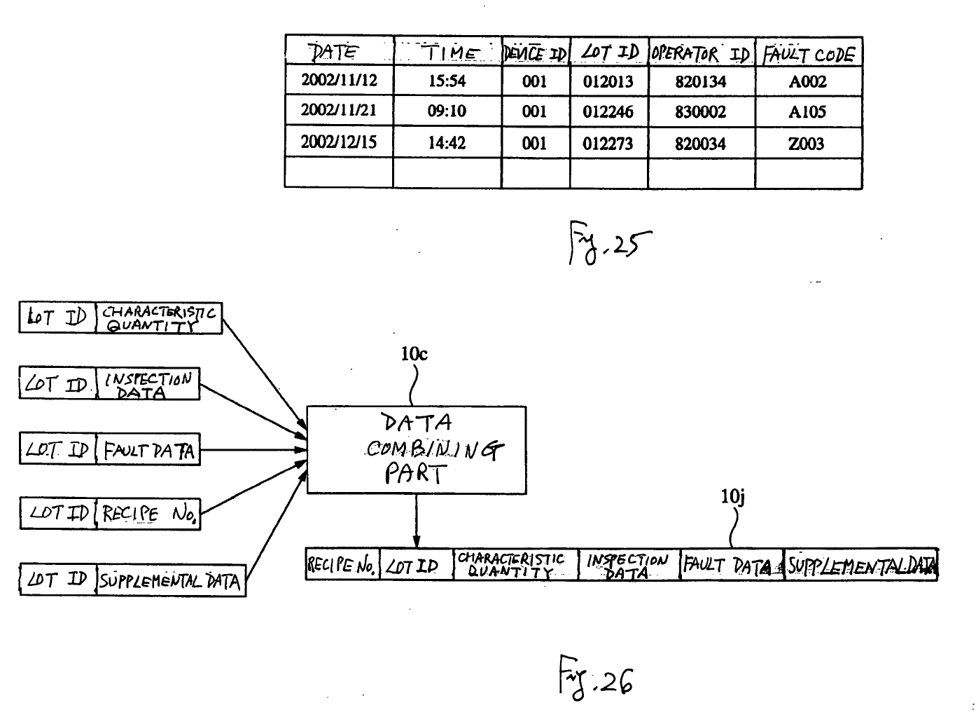

FIG. 26 is a drawing for showing the functions of the data combining part 10c. The data combining part 10c serves to obtain data from the step data memory 10h, the process characteristic quantity memory 10i, the edited inspection data memory 10n and the edited fault data memory 10q, as well as the recipe number obtained from the production management system 9, and to combine these obtained data for each process step by using the recipe number and the lot ID as a key. The combined data thus obtained are stored in the general data memory 10j. In FIG. 26, the supplemental data are the data which are given generally to one or more process steps but were not used in the calculation of process characteristic quantities. The operator data, the maintenance data and the environmental data shown in FIG. 11 and the data having their contents codified are supplemental data. Processes for correlating with corresponding lot ID are carried out on the operator data, the maintenance data and the environmental data, before they are used by the data combining part 10c, on the basis of date and time data and the device ID data to which they are correlated.

The data filter part 10d of FIG. 5 serves to read the combined data stored in the general data memory 10j and to filter out the abnormal data of the characteristic quantities, storing the remaining data in the analysis data memory 10k, as data for analysis. In the above, the abnormal data mean such data containing a number which realistically cannot be. This filtering operation can be carried out by a commonly practiced analytical pre-processing procedure.

The analyzer part 10e serves to read out the aforementioned data for analysis stored in the analysis data memory 10k and to carry out an analysis by a known decision tree which is a common method of analysis for data mining, thereby creating a process-quality model which is an assembly of rules of process status producing good and faulty products.

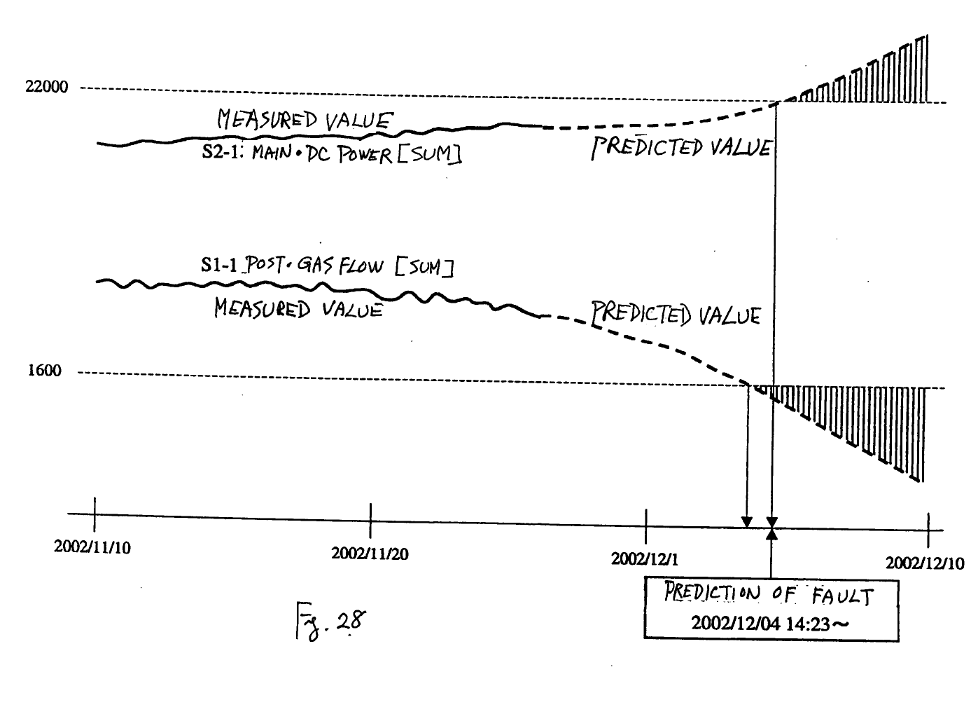

FIG. 27 is an example of process-quality model. This examples uses a rule formula with IF and THEN to show the relationship which numerical range for which characteristic quantity of which step would have which inspection result. Although FIG. 27 shows three rule formulas, it is to be expected in real situations that many more such rule formulas will be generated. The IF statement of a rule formula describes a numerical range of a characteristic quantity in a certain process step and the THEN statement describes information related to inspection result data or fault data for a product. The IF statement may show the presence or absence of certain supplemental data.

To explain the example of FIG. 27 more in detail, the first line of the first IF statement shows a condition (with units omitted) that the cumulative sum (SUM) of the gas flow rate during a certain main processing of Step S2-1 is greater than 2000 liters and less than 2140 liters. There are two other conditions in this IF statement, although detailed explanations of these conditions will be omitted except that RANGE means the range value (or the difference between the maximum and the minimum) and that the overall condition of this IF statement is satisfied when all three conditions connected by “and” are satisfied. The THEN statement shows that the quality of the product is ranked as A (a good product). In summary, this rule formula shows that a good product can be produced if the logical product of the three IF statements is satisfied.

From a rule formula such as shown in FIG. 27, it can be ascertained that a certain relationship between a characteristic quantity and its numerical range within a certain process step (or a combination of such relationships) has an effect on the quality of the product. In other words, relationships between process status and inspection results of products can be learned from such rule formulas. Rule formulas showing a relationship between process status and abnormality or fault of process device may be obtained, as shown at the bottom of FIG. 27. The IF statement of a rule formula may be formed not only regarding a characteristic quantity but also regarding supplemental data such as shown in FIG. 26. The IF statement may say, for example, if there is a code showing a thunder near by.

Many of semiconductor production devices tend to change in one direction as processes are repeated. The invention therefore relates also to the detection of the direction of such a change by using a time series prediction (trend prediction) model by means of the time series analyzer part 10f such that an alarm can be outputted before abnormal products begin to appear or that the time of occurrence of such abnormality can be predicted.

Exponential smoothing models and autoregressive integrated moving-average (ARIMA) models may be used as the time series prediction model. Such a time series prediction model can be created by using an analyzer engine suitable for a particular model to be used and by setting parameters, if necessary. Exponential smoothing models are suitable for predicting a short-term trend and hence are used for predicting faults that are likely to occur unexpectedly. Instead, ARIMA models are for predicting a long-term trend and are used for predicting the timing of faults and abnormalities that are likely to result after a long time of use.

Time series predictions are carried out regarding a characteristic quantity included in a rule formula in the process-quality model and by using a numerical value in a rule formula as a threshold value. Filtered data with abnormal data excluded by the data filter part 10d are used as judgment data (characteristic quantity) for making time series predictions.

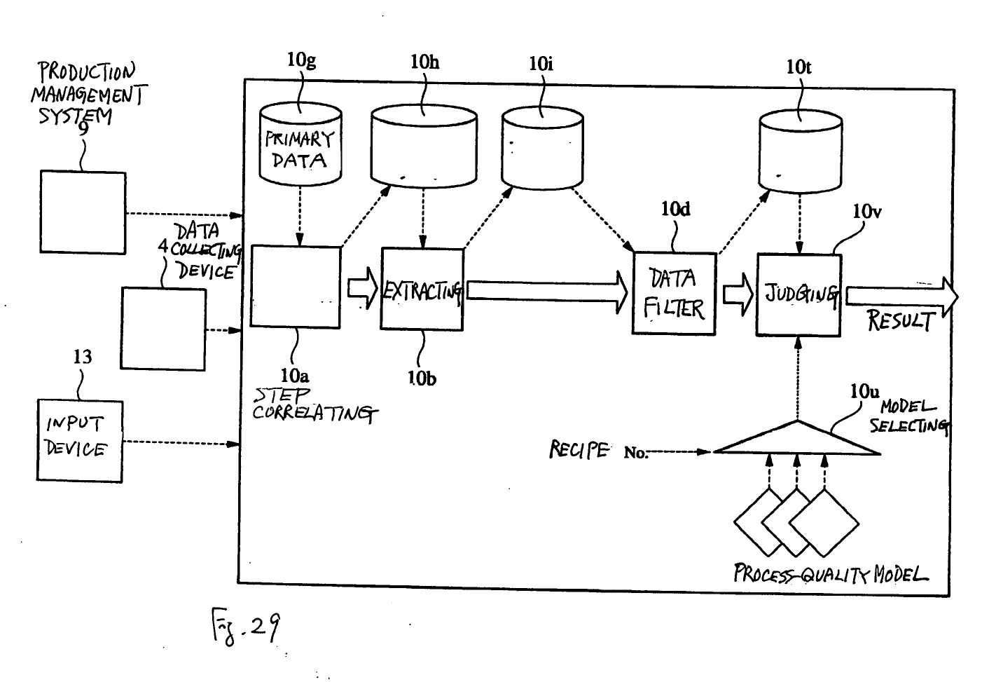

FIG. 28 shows an example of using a time series prediction model. In this example, the cumulative sum value of the DC power in S2-1 Main Processing step and the cumulative sum value of the gas flow rate in S1-1 Post-Processing step are monitored to predict their future values. In this manner, the data and time at which each predicted value will cross over the corresponding threshold value can be predicted. In this example, the threshold values are 22000 and 1600, as shown in FIG. 27. FIG. 28 shows that these threshold values will be crossed at 14:23 on Dec. 4, 2002. When such a prediction is made, the result is displayed on the display device 14 for the operators and the maintenance crew. For creating such a model, an object to be monitored may be selected freely from the characteristic quantities of the process.

Although an embodiment has been described wherein the model creating device 10 is provided with both an analyzer part 10e and a time series analyzer part 10f, it is not always necessary for both of these functions to be provided. The model creating device 10 may be provided without the function of the time series analyzer part 10f.

There are many kinds of products for semiconductor production processes and each has its own recipe number. They are produced by changing their recipe numbers. Thus, process-quality models are created for each recipe number.

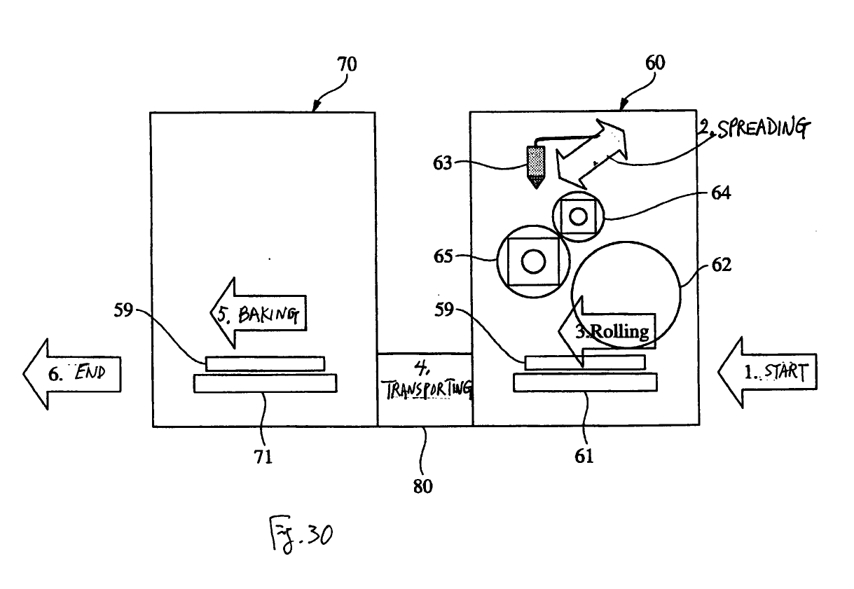

FIG. 29 shows another model creating device according to a second embodiment of the invention provided with a fault detection and classification (FDC) function, that is, the function of using a process-quality model created as explained above to predict the quality of products being processed and to determine the cause of faults. Thus, FIG. 29 shows both elements that were already explained with reference to FIG. 5 and those that are added to the common elements. If only the functions of FDC are required, it is possible to dispense with the elements shown in FIG. 5 but not in FIG. 29.

A model creating device 10 according to the second embodiment, provided with the FDC function, too, is adapted to receive various data from a product management system 9, a process data collecting device 4 and an input device 13 through a network, as the device according to the first embodiment described above. The data received by the model creating device 10 is essentially the same as in the case of the first embodiment. Thus, recipe numbers are obtained from the production management numbers, process status data, lot IDs and wait time data are received from the process data collecting device 4, and operator data, maintenance data and environmental data are received from the input device 13. As in the case of the first embodiment, these received data are stored in the primary data memory 10g.

The step correlating part 10a reads out these data of different kinds stored in the primary memory 10g and determines the periods of steps from the changes in the process status data. Step data with all kinds of data having corresponding process steps are created and stored in the step data memory 10h. The characteristic extracting part 10b reads out these data stored in the step data memory 10h, extracts characteristic quantities of items preliminarily determined for each step and stores them in the process characteristic quantity memory 10i. The data filter part 10d calls out these characteristic quantities stored in the process characteristic quantity memory 10i, carries out the filtering to eliminate abnormal data and thereafter stores the filtered data for judgment in a judgment data memory 10t. The structure of the data for judgment stored in the judgment data memory 10t is the same as that of the data of analysis stored in the analysis data memory 10k according to the first embodiment of the invention described above except that the fault data and inspection result data are removed therefrom.

For the sake of the FDC function, the model creating device 10 according to second embodiment of the invention is provided with a plurality of process-quality models created for each recipe number and a model selecting part 10u which serves to select a model based on the recipe number to transmit it to a judging part 10v. The model selecting part 10u is herein also referred to as a model providng part, serving to accumulate and provide preliminarily created process-quality models.

The judging part 10v reads from the judgment data memory lot, compares it with the rules of a selected process-quality model and can judge the quality of the product being produced from the values of the judgment data corresponding to the rules without making any inspection by means of an inspection device. Since process status data are inputted continuously from one time to the next, a judgment of abnormality may be made even in the midst of an operation by the process device 2. In other words, the processing by the process device 2 or the transportation work to the next step by another device need not be stopped. Moreover, even a fault in the device itself can also be predicted.

Results of judgment can be communicated by displaying on the display device 14. Examples of warning display include: “There is a possibility that products with slightly defective film quality are being produced. Please inspect,” “There is a possibility that products with very defective film thickness are being produced. Please stop the device,” “There is a probability of a fault with Pump A. Please inspect,” and “There is a possibility that Pump A will have a fault soon. Please force it to stop.”

Since a judgment of good and defective products can be made before an inspection can be made with an inspection device and a fault in a device can be preliminary predicted, production of defective products to be discarded can be prevented as much as possible and the loss of processing materials can be reduced. Since loss to a maker of semiconductor products due to defective products is significant, even if the probability of detecting a process abnormality is not reduced to zero, any reduction is a benefit to the industry. Even if the detection percentage is 50%, the loss can be reduced accordingly and the remaining 50% can also be reduced by improving the process-quality models.

If a time series prediction model is further introduced, the judging part 10v can make judgments with prediction. An example of warning in such a situation would be: “There is a possibility from 14:23 on Dec. 4, 2002 that products with very defective film thickness will be produced. Please pay attention.”

The invention has been described above by way of examples applied to a semiconductor production process but the application of the present invention is not intended to be thus limited. The invention can be applied to production processes of many kinds as well as non-production processes.

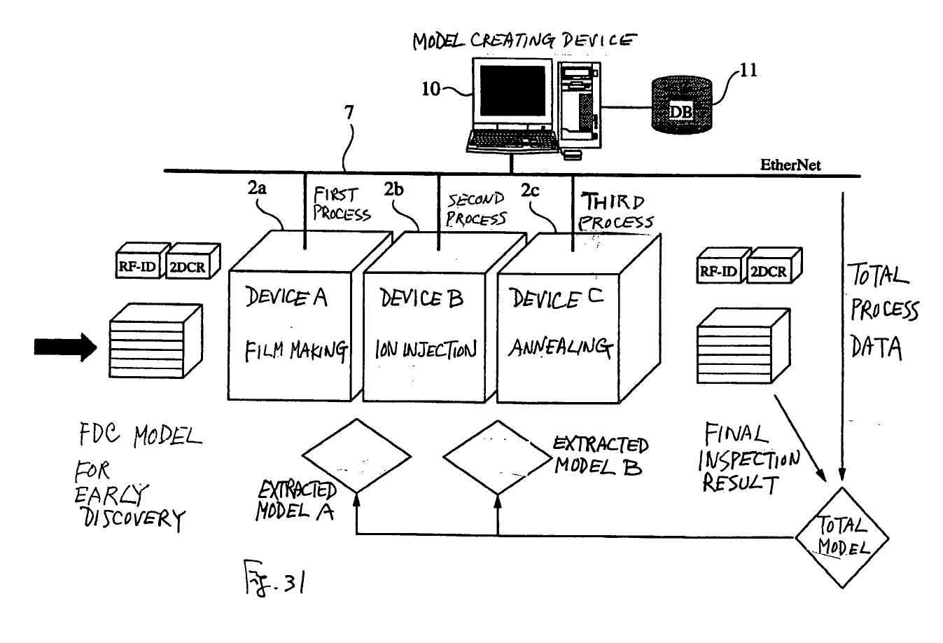

FIG. 30 shows the present invention as applied to a device for applying an alignment film used in the production process for a liquid crystal. The film application device is provided with a printer 60 which serves to print a thin film of polyimide on the surface of a glass substrate 59, a pre-bake oven 70 for pre-baking the printed glass substrate 59 and a carrier robot 80 for transporting the printed glass substrate 59 to the pre-bake oven 70. The printer 60 is provided with a three-dimensionally mobile table 61 on which the glass substrate 59 is disposed. A plate cylinder 62 is positioned above the table 61. A polyimide solution dispenser 63, a doctor roller 64 and an anilox roller 65 are disposed diagonally above the plate cylinder 62. The polyimide solution dropped from the dispenser 63 passes between the doctor roller 64 and the anilox roller 65 such that a uniformly stretched thin film is formed and this thin film is transferred onto the plate cylinder 62. The table 61 moves in synchronism with the rotation of the plate cylinder 62 such that the substrate 59 on the table 61 moves while contacting the plate cylinder 62 such that the polyimide thin film transferred onto the plate cylinder 62 is further printed on the upper surface of the glass substrate 59. The pre-bake oven 70 is provided with a hot plate 71. The printed glass substrate 59 is positioned above the hot plate 71 by means of the carrier robot 80 and is pre-baked by the hot plate 71.

The process by a device thus structured may be divided into the following six steps:
(1) the step of carrying the glass substrate to the printer 60;
(2) the step of dropping the polyimide solution onto the rotating doctor roller and anilox roller such that the solution is uniformly spread and a thin film of the solution is formed;
(3) the step of rotating the plate cylinder 62 while contacting the anilox roller 65 such that the thin film on the anilox is transferred onto the plate cylinder while the table 61 is moved such that the thin film transferred onto the plate cylinder is printed onto the glass substrate 59.

(4) the step of transporting the glass substrate 59 to the pre-bake oven 70 by the carrier robot 80;
(5) the step of pre-baking the glass substrate 59 above the hot plate 81; and
(6) the step of transporting the glass substrate 59 for the next process.

Instead of this example, the step may be divided into “pre-processing,” “main processing” and “post-processing,” as explained above. For example, the step (1) of carrying the glass substrate to the printer may be considered as the pre-processing step, the following four steps (2)-(5) as the main processing and the last step (6) of transporting the glass substrate for the next process as the post-processing step. The process status data such as data on control signals for controlling the operations of various devices and detection signals from detectors belonging to various devices may be utilized for correlating with steps.

Examples of process status data that can be collected to be used for analysis further include the amount of the polyimide solution that is dropped from a solution dispenser 63, rotary speeds of the plate cylinder 62, doctor roller 64 and the anilox roller 65, the direction, distance and speed of the motion of the table 61 and the pressure on the glass substrate 59 from the plate cylinder 62 at the time of printing as well as the temperature and time of heating by the pre-bake oven 70. Regarding both the printer 60 and the pre-bake oven, the temperature and the humidity of the environment may be collected. The recipe number and the work ID are also collected.

These data are supplied to the various devices shown above and the changes in the timing signals are made use of to establish correlation between each of the process status data with a process step. A characteristic quantity is then extracted for each process step and the presence or absence of abnormality and occurrence of fault are predicted by carrying out a specified process.

FIG. 31 is a schematic block diagram of a third embodiment of the invention, showing a system adapted to carry out a series of process steps sequentially by means of a plurality of process devices 2a, 2b and 2c and to thereafter carry out an inspection by means of a inspection device (not shown).

For an analysis of data by a decision tree, inspection result data and fault data are dependent variables and characteristic quantities and supplemental data, if necessary, are used as explanatory variables. In order to obtain a good process-quality model, it is important to exhaustingly include explanatory variables related to dependent variables. Thus, when the result of inspection on a product characteristic that is carried out at the end of a series of production steps, such as the DC current amplification rate hfe of a transistor, is used as an dependent variable, it is necessary to analyze as explanatory variables the process status data obtained from a plurality of devices such as a film making device, an ion injector and an annealing device. The third embodiment of the invention is an example of such a situation.

In such a situation, a process-quality model can be created similarly as explained above with regard to each of the earlier explained embodiments by using the data obtained by each process device and the final inspection result (such as “hfe”). In other words, the lot ID is used as the key to combine the process status data and other data in correlation, extracting a characteristic quantity and filtering.

In addition, this embodiment further provides the function of creating a model for predicting the quality of a completed product in the midst of a series of its production processes. Explained more in detail, in order to be able to detect abnormality already during the processing by the first process device 2a, an extracted (partial) model A is created by extracting a rule related only to the first process device 2a out of the whole of the process-quality model. Similarly, another extracted model B is created by extracting a rule related only to the first process device 2a and the second process device 2b such that abnormality can be detected during the processing by the second process device 2b. In this fashion, it becomes possible to eliminate defective products before the processing by the second process device 2b or the third process device 2c. In summary, faults can be predicted according to this embodiment of the invention at an early stage of the production process and hence the wasteful cost can be reduced accordingly.

Although not shown in FIG. 31, each of the process devices 2a, 2b an 2c is provided with a data collecting device, and data of all sorts collected sequentially are transmitted to the model creating device 10 through the network 7. The aforementioned inspection device (not shown) is also connected to the network 7, including an inspection data collecting device (similar to the one shown in FIG. 1), and inspection result data are transmitted to the model creating device 10 through the network 7. The model creating device 10 also obtains recipe numbers from a production management system (not shown). The internal structure of the model creating device 10 is basically the same as shown in FIG. 5. If necessary, fault data are inputted from the input device 13.

Process status data sent from each of the process devices are stored in the primary data memory 10g, together with the lot ID (lot number), and after correspondence is established by the step correlating part 10a, they are stored in the step data memory 10h. A characteristic quantity is extracted by the characteristic extracting part 10b for each step from the data which are read out of the step data memory 10h, and the extracted characteristic quantity is stored in the process characteristic quantity memory 10i. The final inspection results are stored in the inspection data memory 10m and edited inspection data are generated by the inspection data editing part 10r and stored in the edited inspection data memory 10n.

In this and each of the earlier explained embodiments, if all inspection result data are inputted as code data, the inspection data editing part 10r and the inspection data memory 10m are not necessary and the data may be directly stored in the edited inspection data memory 10n. Characteristic quantities for each process device and for each process step and the total inspection result data are combined by the data combining part 10c by using the recipe number and the lot number as the keys and stored in the general data memory 10j.

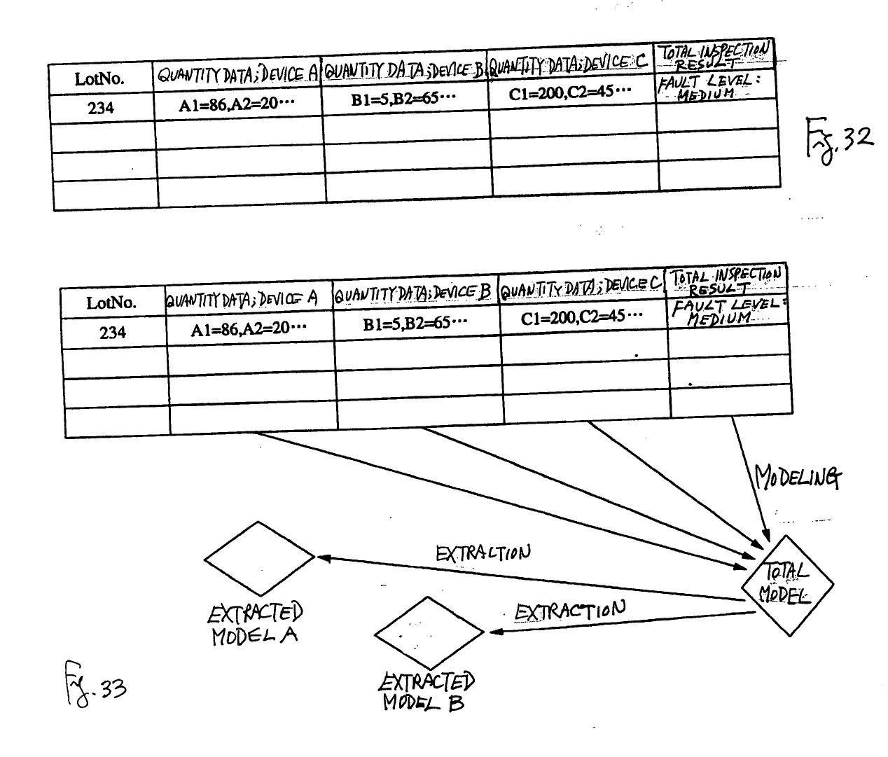

FIG. 32 is a table showing an example of data structure of the general data memory of the third embodiment of the invention with the recipe number omitted and the three process devices indicated as Device A, Device B and Device C. In the entry, A1, A2, B2, etc. indicate individual characteristic quantities. If the kinds of the devices are different, they can generally not have the same characteristic quantities. In this case, too, however, it is desirable to obtain process status data as exhaustingly as possible, corresponding to the type of each device, and to obtain characteristic quantities as exhaustingly as possible.

Abnormal data are eliminated by the data filter part 10d from the combined data stored in the general data memory 10j to generate data for analysis. The analyzer part 10e creates a process-quality model on the basis of these data for analysis.

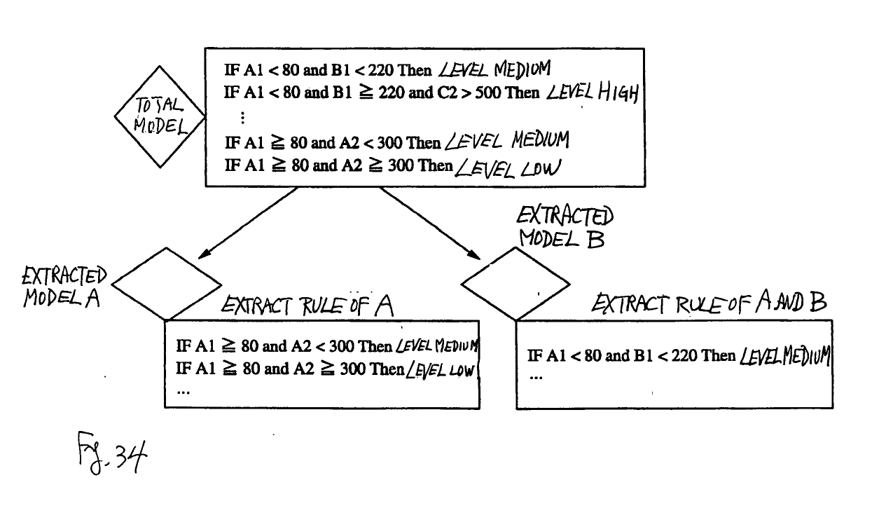

FIGS. 33 and 34 show an example of a process for creating a model according to the third embodiment of the invention. To start, a total model is created. In this process, a plurality of rules are created by a data mining method on the basis of the data from all of the process devices from the data for analysis arranged in one row by using the lot number as the key. Next, the analyzer part 10e extracts extracted models A and B from this total model. An input is made through the input device 13 to indicate which model (model correspond to which process step) should be extracted. This selection may be preliminarily set in the analyzer part 10e.

Extracted model A is created by extracting, from the rule formula of the total model (a process-quality model created by using characteristic quantity corresponding to a group of process steps), the rule formula (partial model) of which the conclusion of the model (the THEN statement) is determined only by the characteristic quantity of Device A (characteristic quantity corresponding to a part of process steps within a group of process steps). In short, extracted model A is created by extracting a rule formula formed only with a characteristic quantity of Device A. Rule formulas with a formula formed only with a characteristic quantity of Device A but combined by an AND with another formula containing a characteristic quantity of another device are not extracted.

Extracted model B is created by extracting, from the rule formula of the total model (a process-quality model created by using characteristic quantity corresponding to a group of process steps), the rule formula (partial model) of which the conclusion of the model (the THEN statement) is determined only by the characteristic quantity of Device A and/or Device B. In short, extracted model B is created by extracting a rule formula formed only with a characteristic quantity of Device A and/or Device B. The other structures, functions and effects of this embodiment are the same as those of the earlier explained embodiments and will not be explained repetitively.

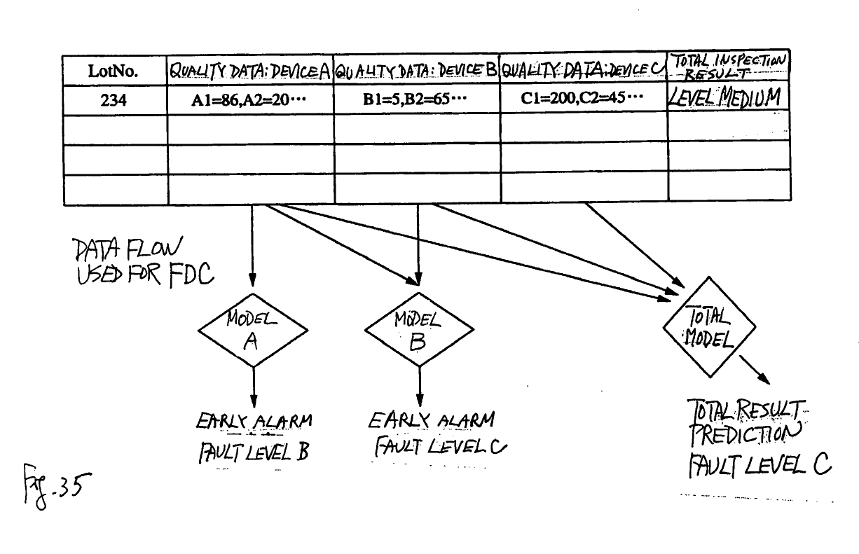

FIG. 35 shows the fault detection and classification (FDC) function in a case where a plurality of process devices are in use. The internal structure of the model creating device 10 for realizing this FDC function is the same as described above regarding the second embodiment of the invention, not being provided with any memories for storing inspection result data and fault data and parts for processing them. The illustrated example is for an application where extracted model A and extracted model B are used. In other words, extracted model A is used when FDC is carried out regarding process by Device A and extracted model B is used when FDC is carried out regarding processes by devices up to Device B. The actual process for judging is the same as described above regarding the second embodiment and hence a repetitive description is omitted.

By this FDC function, too, abnormality is detected at an early stage by an extracted model extracted from the total model. Since the processes after an abnormal condition has been detected are not carried out, the loss due to the occurrence of a fault can be reduced compared to the situation where the abnormality is not detected until the final stage of a series of work steps.

1. A model creating device comprising:
a first input part that inputs process status data, said process status data being related to status of a process and obtained in time series over a period during which each of process steps comprising said process is carried out;
a second input part that inputs inspection result data related to object articles that were processed by said process;
an extracting part that extracts a characteristic quantity from said process status data for every unit object article and for every process step, said unit object article being either one or a group of said object articles; and
an analyzing part that carries out an analysis by data mining by using the characteristic quantities and inspection result data in correlation with said unit object articles, thereby creating a process-quality model that shows a relationship between the correlated characteristic quantities and inspection result data.

2. The model creating device of claim 1 further comprising:
a third input part that inputs object ID data in correlation with the characteristic quantities, said ID data identifying the unit object articles, said second input part inputting said inspection result data in correlation with said object ID data; and
an inspection result correlating part that correlates the characteristic quantities and the inspection results having same object ID data, said analyzing part carrying out said analysis by using the characteristic quantity and the inspection result data that are correlated by said inspection result correlating part.

3. The model creating device of claim 1 further comprising a step correlating part that correlates said process steps and said process status data.

4. The model creating device of claim 3 wherein said step correlating part creates the process steps by using the timings of changes in specified one of the process status data and correlates the created process steps with said process status data.

5. The model creating device of claim 4 wherein said step correlating part creates at least some of said process steps by setting a period by using the timings of changes in specified one of the process status data and by further dividing said set period.

6. The model creating device of claim 3 further comprising a memory device for storing process status data obtained continuously over a plurality of process steps at a fixed frequency period shorter than the shortest of the process steps, in correlation with the times at which said process status data were obtained, said step correlating part serving to read process status data to be used for processing from said memory device.

7. The model creating device of claim 6 wherein the process includes a wait period correlated to a specified one of unit object articles, said memory device storing process data obtained during said wait period in correlation with the time at which said process data were obtained, said step correlating part reading out said process data obtained during said wait period from said memory device and processing said wait period as one of said process steps.

8. The model creating device of claim 1 wherein at least some of the data items of the process data inputted by said first input part are common data items among a group of said process steps, and wherein the characteristic quantity extracted by said extracting part includes common items that are extractable from the common data items of said process status data for each of the process steps of said group.

9. The model creating device of claim 1 wherein said process employs a plurality of process devices, said model creating device further comprising a fourth input part that inputs wait time data in correlation with object ID data identifying a unit object article, said wait time data relating to wait time which is the time spent from when an object article being processed is processed by one of said process devices until when said object article is processed by another of said process devices, said analyzing part carrying out said analysis by using said wait time data correlated with said unit object article as one of the characteristic quantities.

10. The model creating device of claim 2 further comprising a fifth input part that inputs fault data regarding the process device used in the process in correlation with the object ID data, said inspection result correlating part correlating those of the characteristic quantities, the inspection result data and fault data with common object ID data, said analyzing part creating a process-quality model containing a relationship between characteristic quantities and fault data by carrying out said analysis by using the characteristic quantities, the inspection result data and the fault data that are correlated by said inspection result correlating part.

11. The model creating device of claim 2 further comprising a sixth input part that inputs supplemental data, which are given generally to one or more of the process steps, in correlation with the object ID data, said inspection result correlating part correlating the characteristic quantities, the inspection result data and the supplemental data with common object ID data, said analyzing part creating a process-quality model by carrying out said analysis by using the characteristic quantities, the inspection result data and the supplemental data that are correlated by said inspection result correlating part.

12. The model creating device of claim 1 further comprising a time series analyzer part that creates a time series prediction model which predicts changes in the characteristic quantities.

13. The model creating device of claim 12 wherein said time series analyzer part creates said time series prediction model regarding one of the characteristic quantities that has an item in said process-quality model.

14. The model creating device of claim 1 further comprising:
a model providing part that accumulates and provides preliminarily created process-quality models; and
a judging part that detects an abnormality and identifies the kind of the abnormality by applying the characteristic quantities to the process-quantity model.

15. The model creating device of claim 14 further comprising a time series analyzer part that creates a time series prediction model which predicts changes in the characteristic quantities, said judging part detecting abnormalities predicted for future and identifying kinds of the abnormalities by applying characteristic quantities predicted by said time series prediction model to said process-quality model.

16. The model creating device of claim 10 further comprising:
a time series analyzer part that creates a time series prediction model which predicts changes in the characteristic quantities;
a model providing part that accumulates and provides preliminarily created process-quality models; and
a fault judging part that detects a fault predicted to occur in future and identifies the kind of the fault by applying the characteristic quantities to the process-quantity model.

17. The model creating device of claim 1 wherein said process-quality model is created by using characteristic quantities corresponding to a group of the process steps and said analyzing part extracts a partial model from said process-quality model, conclusion of said partial model being determined only by the characteristic quantities corresponding to a portion of the group of process steps.

18. A processing system comprising:
a process device for carrying out a process;
a process data collecting device for collecting from said process device process status data that are related to status of said process and are obtained in time series during a period during which process steps of said process are carried out;
an inspection device that inspects object articles on which said process is carried out; and
a model creating device that inputs said process status data from said process data collecting device, inputs inspection result data and creates a process-quality model which shows a relationship between a characteristic quantity extracted from said process status data and said inspection result data;
wherein said model creating device comprises:
a first input part that inputs said process status data;
a second input part that inputs said inspection result data;
an extracting part that extracts said characteristic quantity from said process status data for every unit object article and for every process step, said unit object articles being either one object article or a group of object articles; and
an analyzing part that carries out an analysis by data mining by using the characteristic quantities and inspection result data in correlation with said unit object articles, thereby creating a process-quality model that shows a relationship between the correlated characteristic quantities and inspection result data.

19. A plasma process system comprising:
a process device having a plasma chamber for a plasma process;
a process data collecting device for collecting from said process device process status data that are related to status of said plasma process and are obtained in time sequence during a period during which each of process steps including a pre-treatment step before a plasma is generated, a main treatment step while said plasma is being generated and a post-treatment step after the generation of said plasma is stopped, is carried out;
an inspection device that inspects object articles on which said plasma process is carried out;
a model creating device that inputs said process status data from said process data collecting device, inputs inspection result data and creates a process-quality model which shows a relationship between a characteristic quantity extracted from said process status data and said inspection result data;
wherein said model creating device comprises:
a first input part that inputs said process status data;
a second input part that inputs said inspection result data;
an extracting part that extracts said characteristic quantity from said process status data for every unit object article and for every process step, said unit object articles being either one object article or a group of object articles; and
an analyzing part that carries out an analysis by data mining by using the characteristic quantities and inspection result data in correlation with said unit object articles, thereby creating a process-quality model that shows a relationship between the correlated characteristic quantities and inspection result data.

20. A method of creating a process-quality model, said method comprising the steps of:
obtaining process status data and inspection result data, said process status data being related to status of a process and obtained in time series during a period during which each of process steps comprising said process is carried out, said inspection result data being related to object articles that were processed by said process;
extracting a characteristic quantity from said process status data for each unit object article and each process step, said unit object article being either one object article or a group of object articles;
correlating the characteristic quantities and the process status data related in common to one of the unit object articles; and
creating said process-quality model by carrying out an analysis by data mining by using said correlated characteristic quantity and process status data, said process-quality model showing a relationship between said correlated characteristic quantity and inspection result data.

21. A fault detection and classification method comprising the steps of:
obtaining process status data and inspection result data, said process status data being related to status of a process and obtained in time series during a period during which each of process steps comprising said process is carried out, said inspection result data being related to object articles that were processed by said process;
extracting a characteristic quantity from said process status data for each unit object article and each process step, said unit object article being either one object article or a group of object articles;
correlating the characteristic quantity and the process status data related to a common one of the unit object articles;
creating a process-quality model by carrying out an analysis by data mining by using said correlated characteristic quantity and process status data, said process-quality model showing a relationship between said correlated characteristic quantity and inspection result data;
obtaining process status data and inspection result data for the same process but related to different unit object articles;
extracting a characteristic quantity from said process status data for said different unit object articles and process steps; and
detecting a fault and identify the kind of said fault by applying said extracted characteristic quantity for said different unit object articles and process steps to said created process-quality model.

22. A fault detection and classification method comprising the steps of:
obtaining process status data and inspection result data, said process status data being related to status of a process and obtained in time series during a period during which each of process steps comprising said process is carried out, said inspection result data being related to object articles that were processed by said process;
extracting a characteristic quantity from said process status data for each unit object article and each process step, said unit object article being either one object article or a group of object articles;
correlating the characteristic quantities and the process status data related in common to one of the unit object articles;
creating a process-quality model by carrying out an analysis by data mining by using said correlated characteristic quantity and process status data, said process-quality model showing a relationship between said correlated characteristic quantity and inspection result data;
obtaining process status data and inspection result data for the same process but related to different unit object articles;
extracting a characteristic quantity from said process status data for said different unit object articles and process steps;
creating a time series prediction model that predicts changes in said characteristic quantity from said process status data for said different unit object articles and process steps; and
detecting a fault and identifying the kind of said fault being predicted to occur in future by applying said changes predicted by said time series prediction model to said process-quality model.

23. A fault detection and classification method comprising the steps of:
obtaining process status data that are related to status of a process and obtained in time series during a period during which each of process steps comprising said process is carried out;
obtaining object article ID data in correlation with characteristic quantities, said object article ID data identifying unit object articles, said unit object articles being each either one object article or a group of object articles;
obtaining inspection result data related to object articles processed by said process in correlation with said object article ID data;
obtaining fault data related to a process device used for said process in correlation with said object article ID data;
extracting a characteristic quantity from said process status data for each of unit object articles and process steps;
correlating characteristic quantity, inspection result data and fault data for having common object article ID data;
creating a process-quality model by carrying out an analysis by data mining by using said correlated characteristic quantity, process status data and fault data, said process-quality model showing a relationship among said correlated characteristic quantity, inspection result data and fault data;
obtaining process status data, inspection result data and fault data for the same process but related to different unit object articles;
extracting a characteristic quantity from said process status data for said different unit object articles and process steps;
creating a time series prediction model that predicts changes in the characteristic quantities from the process status data for the different unit object articles and process steps; and
detecting a fault in said process device and identifying the kind of said fault being predicted to occur in future by applying said changes predicted by said time series prediction model to said process-quality model.
